(19) United States
(12) Patent Application Publication
(10) Pub. No.: US 2012/0226688 A1
(43) Pub. Date: Sep. 6, 2012

(54) Computing systems and methods for electronically displaying and ranking one or more objects with object information

(75) Inventors: William H. Reid, Panama City (PA); Charles Gindi, Panama City (PA)

(73) Assignee: Glabber, Inc, Newark, DE (US)

(21) Appl. No.: 12/932,597

(22) Filed: Mar. 1, 2011

(51) Int. Cl. G06F 17/30; G06F 15/16

(52) U.S. Cl. 707/733; 707/769; 709/203; 707/748; 707/E17.014

(57) ABSTRACT

The present invention relates to computing systems and methods for electronically displaying and ranking one or more objects. Systems and methods may include receiving or providing a rating of an object, as well as other parts of object information, from or by a user. Further aspects may include calculating an object rating and user ratings based on the rating, the previous object rating, and the previous user rating. Further aspects may include calculating an object rating and user ratings based on the rating, one or more previous user ratings of the user, one or more other user ratings of one or more other users that previously provided one or more previous object ratings of the object, and the one or more previous object ratings of the object.

### FIELD OF THE INVENTION

The present invention relates to computing systems and methods for electronically displaying and ranking one or more objects with object information.

### BACKGROUND OF THE INVENTION

Social networking websites focus on building social networks or social relations among people who share the interests, activities or relationships with other people. On such websites, users can share personal information, ideas, activities, events, interests, media, webpages etc. Users can also view other users' personal information, ideas, activities, events, interests, webpages etc. In addition, users may interact and communicate with each other by discussing, sharing and commenting on various items shared by any user.

Media sharing websites allow users to share pictures, audio and videos etc. thereby permitting other users to view and/or listen to the media. Certain of these websites provide information regarding how many times other users have viewed or listened to the media, and further provide comments from users and information regarding whether users liked or disliked the media, and to what extent.

Internet search engines are designed for searching webpages and documents. Internet search engines generally follow a multi-stage process which includes crawling for pages or documents to discover its content; indexing the content in a database or similar structured form (sometimes known as an index); and processing user queries to return search results. Users of internet search engines are most familiar with the last stage in the process, and the search results they receive are often a list of webpages or documents that match or relate to the respective query being used. This last stage of query processing may include traversing an index or database for “hits” or similarities between the terms of the search query and the webpages or documents contained in the database or index. In some instances, the search results are displayed to a user in order from most relevant to least relevant—a type of ranking determined by executing algorithms and not based on substantive user input.

Accordingly, it may be desirable to provide computing systems and methods for electronically displaying and ranking one or more objects.

### SUMMARY OF THE INVENTION

In one aspect, the present invention discloses a method, comprising: receiving by a computing system a command from a user, wherein the command is to rate an object with a particular rating, wherein the computing system includes at least one memory having at least one region for storing computer executable program code and at least one processor for executing the program code stored in the at least one memory, and wherein the computing system is connected to one or more databases in one or more non-transitory computer-readable storage media; transmitting to a site the data; and receiving a second data from the site, the second data including one or more object ratings for the object and one or more user ratings for the user calculated by the site based on the particular rating.

In another aspect, the present invention discloses a programmed computer system, comprising: at least one memory having at least one region for storing computer executable program code and at least one processor for executing the program code stored in the memory, wherein the program code, when executed: transmits to a server data including a command to rate an object with a particular rating; receives a second data from the server, the second data including one or more new object ratings for the object and one or more new user ratings for the user calculated by the server based on the particular rating, one or more previous object ratings for the object, and one or more previous user ratings for the user.

In another aspect, the present invention discloses a one or more non-transitory computer-readable storage media having computer executable software code stored thereon, the code for calculating a ranking, the code comprising: code for transmitting to a server data including a command to rate an object with a particular rating from a user; and code for receiving a second data from the server, the second data including an object rating for the object and a user rating for the user calculated by the server based on the particular rating, a previous user rating of the user, and a previous object rating of the object.

In another aspect, the present invention discloses a computing system, comprising: one or more databases in one or more non-transitory computer-readable storage media, at least one memory having at least one region for storing computer executable program code, and at least one processor for executing the program code stored in the at least one memory, wherein the program code comprises: code to receive an instruction from a user, wherein the instruction is to rate an object; code to calculate an object rating for the object based on the rating, one or more previous user ratings of the user, one or more other user ratings of one or more other users that previously provided one or more previous object ratings of the object, the one or more previous object ratings of the object; code to store the object rating in the one or more databases; and code to post the object rating to a site.

In another aspect, the present invention discloses a method for calculating the rating of an object, the method comprising: receiving by a computing system data from a user, the data including a rating of an object and the computing system having access to one or more previous user ratings of the user, one or more other user ratings of one or more other users that previously provided one or more previous object ratings of the object, the one or more previous object ratings of the object, and one or more user ratings of one or more associated users to a particular degree to the user, wherein the computing system includes at least one memory having at least one region for storing computer executable program code and at least one processor for executing the program code stored in the at least one memory; calculating an object rating for the object and one or more user ratings for the user based on the rating, the one or more previous user ratings of the user, the one or more other user ratings of the one or more other users that previously provided the one or more previous object ratings of the object, the one or more previous object ratings of the object, and the one or more user ratings of the one or more associated users to the particular degree to the user; and storing the object rating and the one or more user ratings in a non-transitory computer-readable storage media.

In another aspect, the present invention discloses a method, comprising: receiving by a computing system a rating of an object from a user on a site, wherein the user provided the rating of the object on the site, and wherein the computing system includes at least one memory having at least one region for storing computer executable program code and at least one processor for executing the program code stored in the at least one memory and is connected to one or more databases in one or more non-transitory computer-readable storage media; calculating one or more object ratings for the object based on the rating; calculating one or more user ratings for the user based on the rating; and storing the one or more object ratings and user ratings in the one or more databases.

In another aspect, the present invention discloses a method, comprising: receiving a command from a user, wherein the command is to add an object and object information associated with the object, wherein the computing system includes at least one memory having at least one region for storing computer executable program code and at least one processor for executing the program code stored in the at least one memory and is connected to one or more databases in one or more non-transitory computer-readable storage media; determining whether the command includes adding an object, and responsive to such a determination, adding the object to a site, and storing the object in the one or more databases; determining whether the command includes adding one or more object information associated with the object, and responsive to such a determination, adding the one or more object information to the site, and storing the one or more object information in the one or more databases; determining whether the object information includes a rating for the object, and responsive to such a determination, calculating one or more object ratings for the object based on the rating, and calculating one or more user ratings for the user based on the rating; storing the one or more object ratings and user ratings in the one or more databases.

In another aspect, the present invention discloses a computing system, comprising: one or more databases in one or more non-transitory computer-readable storage media, at least one memory having at least one region for storing computer executable program code, and at least one processor for executing the program code stored in the at least one memory, wherein the program code comprises: code to receive an instruction, wherein the instruction is to add an object and or interact with the object; code to determine whether the instruction is to add an object and or interact with the object; responsive to determining that the instruction is to add an object: code to add the object to a webpage, and code to store the object in the one or more databases; responsive to determining that the instruction is to interact with the object: code to receive a second instruction, wherein the second instruction is to rate the object and includes a rating for the object, code to calculate an object rating for the object based on the rating, the previous object ratings and the previous user ratings, and code to calculate a user rating for the user based on the rating, the previous object ratings, and the previous user ratings; code to store the one or more object ratings and user ratings in the one or more databases.

In another aspect, the present invention discloses a method, comprising: receiving by a computing system a command from a user, wherein the command is to add an object to a webpage and or interact with the object, wherein the computing system includes at least one memory having at least one region for storing computer executable program code and at least one processor for executing the program code stored in the at least one memory and is connected to one or more databases in one or more non-transitory computer-readable storage media; determining whether the command is to add an object to the webpage and or interact with the object; responsive to determining that the command is to add the object to the webpage on a site: adding the object to the one or more databases and to the webpage; and responsive to determining that the command is to interact with the object: receiving a second command (wherein the second command is to add object information for the object), receiving a third command (wherein the third command is to add a rating for the object), calculating one or more object ratings for the object based on the rating, calculating one or more user ratings for the user based on the rating, and storing the one or more object information and the one or more object ratings and user ratings in the one or more databases.

In another aspect, the present invention discloses a method, comprising: receiving by a computing system a command from a user, wherein the command is to add an object and or interact with the object, wherein the computing system includes at least one memory having at least one region for storing computer executable program code and at least one processor for executing the program code stored in the at least one memory and is connected to one or more databases in one or more non-transitory computer-readable storage media; determining whether the command is to add an object and or interact with the object; responsive to determining that the command is to add the object: adding the object to a site, and storing the object in the one or more databases; and responsive to determining that the command is to interact with the object: receiving a second command (wherein the second command is to rate the object and includes a rating for the object), calculating one or more object ratings for the object based on the rating, calculating one or more user ratings for the user based on the rating, and storing the one or more object ratings and user ratings in the one or more databases.

In another aspect, the present invention discloses a method, comprising: receiving by a computing system a command from a user to perform a search having one or more search criteria, wherein the computing system includes at least one memory having at least one region for storing computer executable program code and at least one processor for executing the program code stored in the at least one memory and is connected to one or more databases in one or more non-transitory computer-readable storage media, and wherein the one or more databases include one or more objects each having one or more object information that includes at least one object rating and at least one identifier designating each user that rated each object, and wherein the user having one or more user ratings; and displaying one or more search results on a page including one or more of the one or more objects having the one or more object information relevant to the one or more search criteria, wherein the one or more of the one or more objects are sorted on the page based on each of their object ratings.

In another aspect, the present invention discloses a method, comprising: receiving by a computing system a command from a user to perform a search having one or more search criteria, wherein the computing system includes at least one memory having at least one region for storing computer executable program code and at least one processor for executing the program code stored in the at least one memory and is connected to one or more databases in one or more non-transitory computer-readable storage media, wherein the one or more databases include one or more objects each having one or more object information that includes at least one object rating and at least one identifier designating each user that rated each object, and wherein the user having one or more user ratings; and displaying one or more search results on a page including one or more of the one or more objects having the one or more object information relevant to the one or more search criteria, wherein the one or more of the one or more objects are sorted on the page based at least on the one or more user ratings.

In another aspect, the present invention discloses a computing system, comprising: at least one memory having at least one region for storing computer executable program code, and at least one processor for executing the program code stored in the memory, wherein the program code, when executed: allows a user to access a site; displays a page on the site to the user, the page including one or more first objects that the user assigned one or more first object information and one or more second objects that one or more associated users to the user to a particular degree assigned one or more second object information; and updating the page with one or more first new objects that the user assigned one or more first new object information and one or more second new objects that the one or more associated users to the user to the particular degree assigned one or more second new object information.

In another aspect, the present invention discloses a computing system, comprising: at least one memory having at least one region for storing computer executable program code, and at least one processor for executing the program code stored in the memory, wherein the program code, when executed: allows a user to access a site and designate one or more subject matter classifications, wherein the subject matter classifications designate one or more categories of subject matter in one or more sections of the site or one or more other sites; and displays a page on the site to the user, the page including one or more objects having one or more object information, wherein the one or more object information includes at least one of the one or more subject matter classifications that the user designated.

In another aspect, the present invention discloses a computing system, comprising: at least one memory having at least one region for storing computer executable program code, and at least one processor for executing the program code stored in the memory, wherein the program code, when executed: displays a webpage on a site associated with a particular subject matter, the page including one or more objects having one or more object information that references the particular subject matter; and allows one or more users to update the one or more object information.

In another aspect, the present invention discloses a method, comprising: receiving by a computing system a command from a user, wherein the computing system includes at least one memory having at least one region for storing computer executable program code and at least one processor for executing the program code stored in the at least one memory and is connected to one or more databases in one or more non-transitory computer-readable storage media, wherein the command is to add an object, and wherein the object includes a link and data associated with a minimum degree of change associated with the link required for notification of the user; determining whether the command is to add an object, and responsive to such a determination, adding the object to a site and storing the object in the one or more databases; retrieving a first webpage associated with the link; storing the first webpage in the one or more databases; retrieving a second webpage associated with the link; storing the second webpage in the one or more databases; determining a calculated degree of change, wherein said determination of a calculated degree of change includes comparing the first webpage with the second webpage and calculating a percentage difference between the first webpage and the second webpage; determining whether the calculated degree of change is equal to or greater than the minimum degree of change, and responsive to such a determination, notifying the user that the link has updated.

In another aspect, the present invention discloses a programmed computer system, comprising: at least one memory having at least one region for storing computer executable program code, at least one non-transitory computer-readable storage media, an internet browser installed on the programmed computer system, a software application installed on the programmed computer system's internet browser and stored in the at least one non-transitory computer-readable storage media, wherein the software application includes an interface to assign one or more object information associated with a webpage to a server and or to assign one or more object information associated with one or more objects on the webpage to the server, at least one processor for executing the program code stored in the memory, wherein the program code, when executed: receives a request from a user to display the webpage and displays the webpage in the internet browser; receives one or more first commands from the user to assign one or more object information associated with the webpage to the server and or to assign one or more object information associated with one or more objects on the webpage to the server, wherein the one or more first commands are received via the interface on the internet browser; determines whether the one or more first commands includes assigning one or more object information associated with the webpage to the server, and responsive to such a determination, transmits to the server data including one or more second commands to add the webpage and the one or more object information associated with the webpage to the server, wherein the one or more second commands are transmitted to the server via the interface on the internet browser; determines whether the one or more first commands includes one or more object information associated with one or more objects on the webpage to the server, and responsive to such a determination, transmits to the server data including one or more third commands to add the one or more objects and the one or more object information associated with one or more objects on the webpage to the server, wherein the one or more third commands is transmitted to the server via the interface on the internet browser.

In another aspect, the present invention discloses a computing system, comprising: at least one memory having at least one region for storing computer executable program code, and at least one processor for executing the program code stored in the memory, wherein the program code, when executed: displays a webpage on a site associated with an area, section or subsection of the site, wherein the webpage includes one or more objects having one or more object information associated with the area, section or subsection, and wherein the one or more objects on the webpage are sorted on the webpage based on their object ratings; receives from one or more users edits to one or more of the one or more object information; and updates the webpage based on the edits received from the one or more users.

### BRIEF DESCRIPTION OF THE DRAWINGS

Features and other aspects of embodiments of the present invention are explained in the following description taken in conjunction with the accompanying drawings, wherein:

FIG. 1 illustrates a system according to one aspect of the present invention;

FIG. 2A illustrates user association according to one aspect of the present invention;

FIG. 2B illustrates a homepage according to one aspect of the present invention;

FIG. 3 illustrates a non-transitory computer-readable storage media containing one or more databases according to one aspect of the present invention;

FIG. 4 illustrates a method according to one aspect of the present invention;

FIG. 5 illustrates a method according to another aspect of the present invention;

FIG. 6 illustrates a method according to another aspect of the present invention;

The drawings are exemplary, not limiting. It is intended for items that are labeled with the same number in multiple figures to refer to the same item throughout the figures.

### DETAILED DESCRIPTION

Various embodiments of the present invention will now be described in greater detail with reference to the drawings.

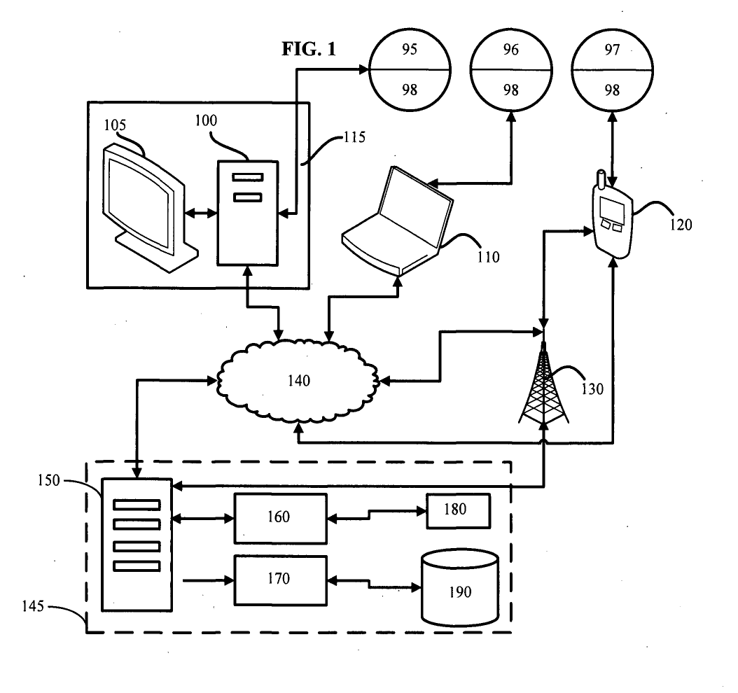

As shown in FIG. 1, one aspect of the present invention may include one or more users 98 of user types 95, 96, and 97 operating one or more computing systems 115, 110 and/or 120 that are directly and indirectly connected to one or more host servers 150 through network 140 or cellular network 130. Host servers 150 may be directly or indirectly connected to, or may include, one or more web server managers 160 and one or more database servers 170. Web server manager 160 may interface with one or more web servers 180 to host site 145. Database server 170 may interface with one or more databases 190. Computing Systems 115, 110, and/or 120 may receive input data from one or more users 98.

In one aspect, a computing system may be any single or set of hardware equipment that is encoded and able to accept user input from one or more users 98 and transmit data based on the user input through network 140 and/or cellular network 130 to one or more host servers 150. The computing system may include one or more non-transitory data storage devices or computer-readable storage media, such as harddrives, RAM, ROM, CD-ROM, DVD-ROM, floppy-disk drives, and/or solid-state memory drives; one or more input devices, such as a keyboard, touchpad, mouse, keypad, touchscreen and/or stylus; one or more central processing units (CPUs); one or more output devices, such as a display, disc drive, and/or solid-state memory drive; one or more input/output (I/O) communications ports, such as an infrared port, universal serial bus port, serial port, Ethernet port, cellular port, HDMI port, Display port, modem port, Bluetooth port, and/or wireless networking controller. The hardware may be in communication with one another by a shared data bus and/or by dedicated connections. The computing system may have one or more memory with at least one region for storing computer executable program code and one or more CPUs=or processors=for executing the program code stored in the memory.

In one aspect, the computing system 120 is a mobile phone. In another aspect, the computing system 110 is a laptop, netbook, or other type of portable computer. In another aspect, computing system 115 includes a computer 100 and display 105. Display 105 may be a liquid crystal display (LCD), light emitting diode (LED) display, cathode-ray tube (CRT) display, or organic light emitting diode (OLED) display. Computing system 115 and 110 may be a computer that generally includes one or more data storage devices, one or more CPUs, one or more input devices, one or more output devices, one or more I/O communications ports, and other hardware components that facilitate performance of the functions of computing systems 115 and 110. Computing systems 115 and 110 may be a tablet PC; alternatively, computing systems 115 and 110 may be a laptop computer. In another aspect, a computing device may include a mobile phone 120 tethered to computing systems 115 and/or 110.

Network 140 may include any type of network infrastructure, such as client/server, peer-to-peer, or hybrid architectures. Network 140 may include the Internet. In one aspect, cellular network 130 is any cellular network. Cellular network 130 may operate under any mobile telephony standard such as 0G, 1G, 2G, 2G transitional, 3G, 3G transitional, 4G, pre-4G and/or other GSM, UTMS, TDMA, CDMA, GPRS, EDGE, mobile WiMax, or LTE related standard. Cellular network 130 may be directly or indirectly connected to network 140 and/or host servers 150.

One or more host servers 150 may be one or more remote computing systems that are accessible over a remote or local network or the Internet, such as network 140, or through wireless network infrastructures, such as cellular network 130. Host servers 150 may have all of the hardware attributes of computing systems 115 and 110. Host servers 150 may be distributed over two or more physical locations. Host servers 150 may include one or more web server managers 160 that are directly or indirectly connected to one or more web servers 180, and one or more database server managers 170 that are directly or indirectly connected to one or more databases 190. Web server managers 160, web servers 180, database server managers 170, and databases 190 may have—or be run on computing systems with—all of the hardware attributes of computing systems 115 and 110. Web servers 180 may run, for example, Apache, Microsoft IIS, nginx, GWS, lighttpd, qq.com, or Sun. One or more databases 190 may be any type of database, such as analytic, operational, hierarchical, network, or relational databases. For example, Microsoft SQL Server, MySQL, Oracle Database, Microsoft Access, Microsoft Excel file, and/or comma separated value or tab-delineated file. In another aspect, databases 190 may be—or include—any type of data structure, or nested data structures, such as tables, stacks, queues, lists, linked-lists, arrays, trees, and/or heaps. One or more databases 190 may store one or more objects 101, object information 102, user profiles, and user information.

Site 145 may include one or more websites that, in turn, include one or more webpages, including homepage 99, that transmit data to one or more users 98 through networks 130 and/or 140. Such data may be accessed through a browser like, for example, Google's Chrome, Microsoft's Internet Explorer, Mozilla's FireFox, Safari or Opera. Such data may then, in turn, be displayed to one or more users 98 through display 105, the display in computing system 110, and/or the display in computing system 120. Site 145 may sit on top of, communicate with, and/or include back-end infrastructure, such as one or more host servers 150, one or more web server managers 160, one or more database server managers 170, one or more web servers 180, and one or more databases 190. Site 145 may be searched by one or more users 98 by users 98 entering input into an interface on site 145 and site 145 traversing or otherwise searching one or more databases 190 using database server manager 170. Results from such searching may be returned from the database server manager 170 to web servers 180 and/or web server managers 160 and then transmitted to the user 98 on site 145.

One or more users 98 may have different levels of access to data accessible on site 145 and/or transmitted by one or more of host servers 150, web server managers 160, web servers 180, database server managers 170, and databases 190. For example, a user 98 may have user type 95, which may correspond to basic user-level access. Basic user-level access may allow the user 98 to develop and/or post objects 101 and/or object information 102 to site 145 as well as edit objects 101 and/or object information 102 that user 98 posts to site 145. Alternatively, the user 98 may have user type 96, which may correspond to system administrator-type access, like that of a system operator. System administrator-type access may allow the user 98 to do everything a user of type 95 may do, as well as edit objects 101 and/or object information 102, regardless of the user 98 that posted the objects 101 and/or object information 102. Alternatively, the user 98 may have user type 97, which may correspond to root access. Root access may allow the user 98 to do everything users of types 96 and 95 may do, as well as revise the actual site 145 software infrastructure, such as scripts, HTML, graphics, or other code related to site 145.

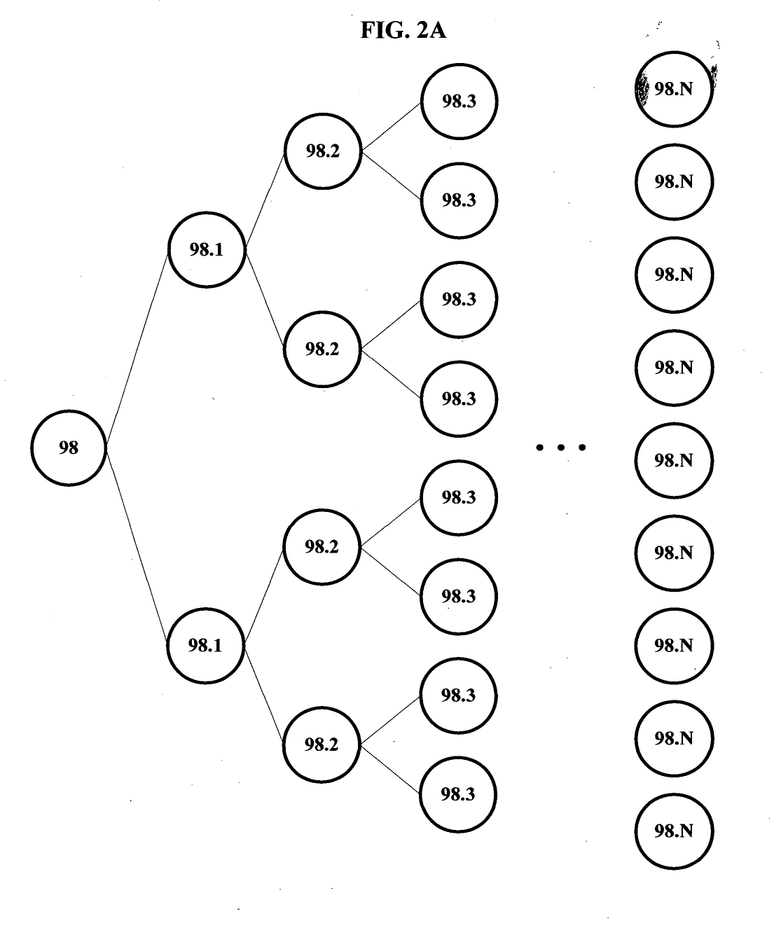

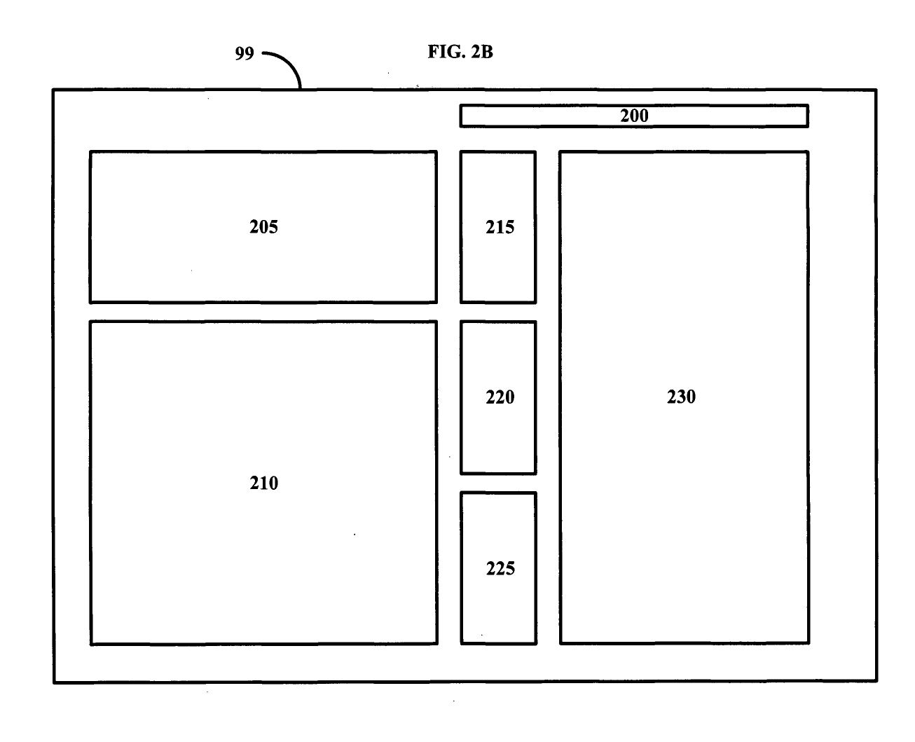

As shown in FIG. 2A, according to one aspect of the present invention, the user 98 may become associated with one or more other users 98.1 on or otherwise associated with site 145 when user 98 designates on site 145 that he or she would like to associate with one or more particular other users 98.1. User association on site 145 can be calculated to any degree. For example, if the user 98 chooses to associate with a particular other user 98.1, then the user 98 will be associated with to a second degree all users 98.2 the particular other user 98.1 is associated with to a first degree that are not otherwise associated with the user 98 in a lower degree. In such an example, the user 98 will be associated with to a third degree all users 98.3 the particular other user 98.1 is associated with to a second degree that are not otherwise associated with the user 98 in a lower degree. The first degree of user associations of each user may be stored in one or more databases 190 as user information, and other higher degrees of associations of each user may be calculated by tracing each user's first degree of user association. In other aspects, each user's associations up to a designated degree 98.N may be stored in one or more databases 190 as user information for each user. In one aspect, each user's associations up to an unlimited degree may be stored in one or more databases 190 as user information for each user. Site 145 can filter the associated users for the user 98 to any particular degree and display, for example as an update, user information or public user profiles for the associated users to the particular degree on the user 98's homepage 99 (as shown in FIG. 2B according to one aspect of the present invention). In another aspect, public user profiles are portions of the user profile that are available for other users to view. The user 98 may designate the particular degree or type of information considered to be included in the user 98's public user profile, or it may be set as a default.

As further shown in FIG. 2B, according to one aspect, each user 98 may have one or more homepages 99. Homepage 99 may be a default screen or page which a user 98 is sent to when accessing site 145 before or after login credentials have been verified by site 145. Homepage 99 may also be a screen or page that the user 98 may access by, for example, clicking on a hyperlink or other link to the address of homepage 99. A homepage may also be a screen or page that may be viewed by any user or just associated users to the user to a particular degree. One or more objects 101 may be embedded or otherwise appear on each user 98's homepage 99. In one aspect, the user 98's homepage 99 accesses one or more databases 190 to display the activity on site 145 of the user 98's associated users to a set or designated degree.

For example, such activity may include a log or summary of object information 102 added to one or more objects 101 by an associated user of the user 98. In further aspects, the user 98's homepage 99 displays one or more objects 101 that have object information 102 that are related to a particular topic that the user has designated as interesting. Such topics of interest may be updated by any of one or more other users of site 145. In yet further aspects, the user 98's homepage 99 contains objects 101 in the form of links. Such links may include URLs that the user 98 manually adds to homepage 99 or site 145 by inputting the URLs into an input prompt or other interface on homepage 99 or site 145 or uploads to homepage 99 or site 145 by importing the user 98's “favorites” or “bookmarks” from the user 98's web browser software or operating system. In one aspect, such links may appear in the links section on the user 98's homepage 99, and/or may be stored in one or more databases 190. Links may also include page links, or URLS that the user 98 or other users on site 145 manually input, import, or otherwise upload. In one example, if the user 98 added links to the links section on the user 98's homepage 99, then the user 98 will receive updates on the user 98's homepage 99 relating to these links, which notify the user 98 that data associated with the links has changed. This occurs when, for example, the one or more webpages associated with the links has been updated. In one aspect, site 145 may provide the user 98 with the ability to control the minimum degree of change required on the webpage associated with the link before the user 98 is notified. The user 98 may, for example, choose not to be notified of immaterial changes on a website associated with the link. In another aspect, the user 98's homepage 99 may be updated to remove objects 101 that no longer have certain object information 102.

The user 98's homepage 99 may be updated each time the user 98 logs into site 145, at a certain duration (e.g., every 5 seconds, every 5 minutes, etc.), on a particular event (e.g., each time the user 98 posts a new object 101, each time the user 98 posts new object information 102, each time the webpage associated with the link added by the user 98 has changed and/or updated, each time a topic of interest added by the user 98 has updated, each time an associated user of the user 98 posts a new object 101 or new object information 102, or each time there is general activity of an associated user of the user 98, etc., or manually by the user 98 as user type 95, 96, and/or 97.

In one aspect, homepage 99 may include a user options control panel 200 where the user 98 may control the updates appearing on the user 98's homepage 99 and a search field 250 where the user 98 may perform a search for users or “people”, a search for objects 101 on site 145 and/or the World Wide Web, or a detailed search; search results 230; a display of the user 98's user profile information, photo, audio and video albums 205; a field and area 210 which may display the user 98's status updates, objects 101 including the user 98's communications and communications from the user 98's associated users; a listing 215 of associated users of the user 98; a listing 220 of links and those objects' 101 object information 102, referred to as “links section”; a listing 225 of interests and object information 102 of those objects 101, referred to as “interests section”; a summary of updates 230 related to associated users of the user 98, such as changes in those associated users' user ratings, objects 101 added by those associated users and/or objects 101 which those associated users assigned object information 102 to and recent general activity of those associated users, recent general activity of objects 101 added by the user 98 to site 145 or any website, recent general activity of objects 101 in the form of interests from the interests section and links from the links section, and those objects' 101 object information 102.

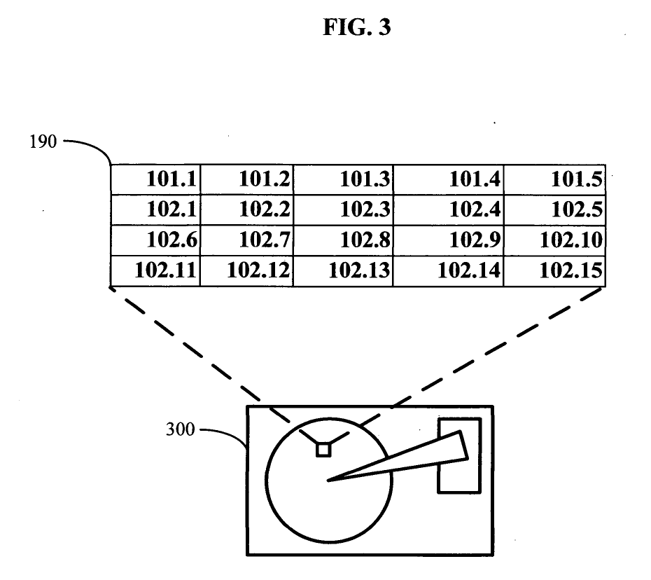

One or more host servers 150 may access, receive, store, generate, and transmit one or more objects 101 and/or object information 102. One or more host servers 150 may store objects 101 and object information 102 in one or more databases 190, web servers 180, other file servers, otherwise in site 145, or directly into a non-transitory computer-readable storage media. FIG. 3 shows objects 101.1, 101.2, 101.3, 101.4, and 101.5 and object information 102.1, 102.2, 102.3, 102.4, 102.5, 102.6, 102.7, 102.8, 102.9, 102.10, 102.11, 102.12, 102.13, 102.14, and 102.15 stored in one or more databases 190 in non-transitory computer-readable storage media 300 according to one aspect of the present invention.

In one aspect, object 101 is a (1) link, such as a hyperlink, (2) picture file, (3) video file, (4) audio file, (5) other multimedia file, (6) text, (7) phrase, (8) question, (9) interest, (10) network, (11) any section on site 145 or any website, (12) search term, for example, one or more key words, phrases, or questions, (13) a set of all or certain results effected by a search term on, for example, a search engine website, (14) news, (15) scholarly article, (16) blog, (17) blog entry, (18) wiki, (19) wiki entry, (20) comment, (21) quote, (22) piece of information, (23) piece of communication, (24) anything that could be shared by digital means, or (25) other data capable of being rated by one or more users 98, all of which may be on site 145 or any website. Each object 101 may reference object information 102. In one aspect, a link to object 101 and object 101's object information 102 are stored in linked fields in one or more databases 190. Object 101 may be input by the user 98 on site 145 or any website, and stored in one or more databases 190 or otherwise uploaded by the user 98 to site 145 or any website and stored in one or more databases 190, web servers 180, and/or file servers.

Object information 102 is one or more data attributes associated with a particular object 101. In one aspect this data may be assigned by the user 98 on site 145 or any website, or it may be assigned automatically by site 145. In another aspect, object information 102 may be assigned when an object 101 is added or after an object 101 has been added.

Object information 102 may include one or more (1) search terms; (2) key words; (3) related topics; (4) interests; (5) interests sections on site 145; (6) networks; (7) networks sections on site 145; (8) objects 101; (9) ratings based on object information 102; (10) ratings based on quality; (11) piece of information; (12) definitions where the object 101 is recent news in a designated section on site 145; (13) definitions where the object 101 is news in a designated section on site 145; (14) definitions where the object 101 is associated with a wild in a designated section on site 145; (15) definitions where the object 101 is associated with a search section under designated keywords phrases, or questions on site 145; (16) definitions where the object 101 is associated with a photo, video, or other multimedia file or album in a designated section on site 145; (17) definitions where the object 101 is associated with a photo area in a designated section on site 145; (18) definitions where the object 101 is associated with a video area in a designated section on site 145; (19) definitions where the object 101 is associated with a blog, including a blog in a designated section on site 145; (20) definitions where the object 101 is associated with an area in a designated section on site 145 or on any website; (21) definitions where the object 101 is associated with a designated section on site 145 or any website; (22) dates on which object 101 was added to site 145 or any website; (23) dates on which object 101 was added to a particular area and/or section on site 145 or any website; (24) dates on which object 101 was added to a particular page, such as homepage 99, in site 145 or any website; (25) dates on which object information 102 was added to object 101; and (26) other attributes of object 101.

Assigning object information 102 allows users 98, site 145 or any website to place object 101 in many different relevant areas of site 145 or any website in an easy interface. In one aspect, assigning object information 102 may assist in defining an object 101 and its relevancy. In another aspect, object's 101 relevancy may be further enhanced by means of a rating based on object information 102 and/or considering the individual user ratings of the users (for credibility) who rated the object 101. Related topics include one or more topics that one or more users 98 designate as having a certain or sufficient relation and/or relevancy to a particular object 101. In one aspect, related topics may each individually become a designated section, interest or interest section, network or network section, on site 145 or any website. Recent news is part of a designated section on site 145 and it includes the latest news from users 98, wires, such as from the Associated Press, or other news sources that are relevant to the topic of the designated section on site 145.

In one aspect, a rating is any representation of quality and/or relevance—such as: a number, a letter (e.g., A-F scale), a collection of stars (e.g., five stars, each star worth 20%, each half-star worth 10%), a smiley/frown face, “likes” or “dislikes”, one or more thumbs up/down, and/or a color—that is assigned to object 101 or the user 98. Ratings may be hierarchical in that they may be sorted in ascending or descending order. A rating may be on a scale from 1-10, 1-100, 1-1000, A-Z, or agree/disagree. Objects 101 and users 98 may have ratings. User ratings may be classified as user information which may be stored in linked fields to user profiles in one or more databases 190.

A rating of object 101, or object rating, may be calculated based on one or more of (1) object 101's specific rating, (2) object 101's overall rating, (3) each specific user rating for the one or more users 98 that either posted or rated object 101 either at the time the one or more users 98 made the rating or at the time the rating of object 101 is calculated, and (4) each overall user rating for the one or more users 98 that either posted or rated object 101 either at the time the one or more users 98 made the rating or at the time the rating of object 101 is calculated.

A specific rating of object 101, or specific object rating, is the rating of object 101 in a particular subject matter. An overall rating of object 101, or overall object rating, is the rating of object 101 in all subject matter areas in which the object 101 has been posted or rated. A specific user's rating, or specific user rating, is the rating of the user that posts a particular object 101 or rates a particular object 101 in the particular subject matter area in which the user posted or rated the object 101. An overall user's rating, or overall user rating, is the rating of the user in all subject matter areas in which the user has posted or rated objects 101. The object rating may be recalculated each time a user's specific or overall rating changes if the user either posted or rated the object 101. The user rating may be recalculated each time the objects' specific or overall rating changes if the user either posted or rated the object 101. The user rating may be recalculated each time one of the other users' specific or overall rating changes if one of the other users either posted or rated the same object 101. In another aspect, the object rating and/or user rating may be recalculated at a certain duration, on a particular event, or manually by the user 98 as user type 95, 96, and/or 97.

In one aspect, ratings given by users that have higher specific user ratings in a particular subject matter area will have more impact on the rating of an object 101 in that particular subject matter area than users that have lower specific user ratings in that particular subject matter area. Ratings given by users that have higher overall user ratings will have more impact on the rating of an object 101 than users that have lower overall user ratings. An object 101 that has a high specific object rating may have its ratings influenced more by users that have a higher specific user rating than the object 101's specific object rating rather than by users that have a lower specific user rating than the object 101's specific object rating. An object 101 that has a high overall object rating may have its ratings influenced more by users that have a higher overall user rating than the object 101's overall object rating rather than by users that have a lower overall user rating than the object 101's overall object rating.

A rating of a user, or user rating, may be calculated based on one or more of (1) the user's specific user rating(s)—that is, in a particular subject matter; (2) the user's overall user rating—that is, across all subject matters; (3) each users' specific user rating(s) that rated the user; and (4) each user's overall user rating that rated the user. In another aspect, the user's overall user rating is across only those subject matters in which the user has posted or rated objects 101. User's specific user rating(s) and overall user rating may be calculated—or recalculated—when a user rates an object 101 or another user. Ratings given by users that have higher specific user rating(s) in a particular subject matter area will have more impact on the rating of another user in that particular subject matter area than users that have lower specific user rating(s) in that particular subject matter area. Ratings given by users that have a higher overall user rating will have more impact on the rating of another user than users that have a lower overall user rating. Users that have high specific user rating(s) may have their rating(s) influenced more by other users that have higher specific user rating(s) than the user's specific user rating(s) rather than by other users that have lower specific user rating(s) than the user's specific user rating(s). Users that have a high overall user rating may have their ratings influenced more by other users that have a higher overall user rating than the user's overall user rating rather than by other users that have a lower overall user rating than the user's overall user rating.

In one example, the user 98, User1, searches a website and/or World Wide Web for “Basketball” and is returned an object 101: a link to a website with an article on it about the New York Knicks winning a game earlier that day. User1 may then assign object information 102 to object 101—for example, User1 may assign object 101 to the recent news part of the Basketball section of site 145, the wild part of the Basketball section of site 145 and the recent news part of the New York Knicks section of site 145. User1 may then assign one rating to object 101 for all three sections, or three ratings for object 101 for each of the 3 sections based on the relevance of the recent news post to the Basketball section of site 145, based on the relevance of the wild post to the Basketball section of site 145 and based on the relevance of the recent news post to the New York Knicks section of site 145. The object may now appear in those sections of site 145. User 1 may assign object information, like in this example, to any search result object on site 145 or any page on any website when User 1 is searching a website and/or World Wide Web. In another aspect, User 1 may assign object information, like in this example, to any object on site 145 or any page on any website when User 1 is not searching. If User1 was the first user to add object 101 to the recent news part of the Basketball section of site 145, then other users may now rate that object 101 for its relevance in the recent news part of the Basketball section of site 145. User1's specific user rating in Basketball may be determined based on the deviation of User1's rating of the object 101 from the object rating of object 101. In some aspects, (1) the degree to which User1's rating of the object 101 agrees with other users' ratings of the object 101 that have favorable specific user ratings, e.g., in Basketball and overall user ratings, and (2) the amount of other users' ratings that agree with User1's rating will influence User1's specific user rating and User1's overall user rating.

Favorable specific user ratings are those that exceed a particular threshold rating, which may be set by a system administrator. The level of favorability may increase or decrease depending on how far the rating is from the threshold. Users who have a specific user rating that exceeds a particular threshold rating may further be considered experts in that particular subject matter. The closer a user's specific user rating is to a threshold rating in a particular subject matter area, the more influence that user's specific user rating will have on the rating of an object 101 or user in that particular subject matter area. In one example, users with a high specific user rating in Basketball may disagree with User1's rating of the object 101, which will decrease User1's specific user rating and overall user rating and affect object 101's specific object rating and object overall rating based on the other user's rating. If many users with low overall user ratings in Basketball also disagree with User1's rating of the object 101, then User1's specific user rating and overall user rating and the object 101's specific object rating and overall object rating may continue to decrease, the expert's specific user rating and overall user rating may increase, and the many users' specific user ratings and overall user ratings may increase. In another aspect, however, many users' specific ratings may be so low that it does not affect the object 101's rating, User1's rating, nor the expert's rating.

In further aspects, specific object ratings, overall object ratings, specific user ratings, and overall user ratings may be affected by one or more of (1) a user's general activity on a website; (2) other users' general activity on a website who have rated the same object 101 or user; (3) the general activity on a website of the object 101 or user in question; (4) verification through one or more methods that a user is a genuine person, and not a program created to influence ratings; (5) the amount of ratings a user has made on a website; (6) the time between ratings a user has made on a website; (7) the overall time a user has been rating on a website; (8) the number of associated users to a user; (9) the number of associated users to a user's associated users; (10) the number of associated users of one or more degrees to a user; (11) the general activity of associated users of one or more degrees to a user; (12) the ratings of associated users of one or more degrees to a user; (13) activity signals that a user may not be objectively rating objects; (14) a user's Internet Protocol (IP) address and other technical information; (15) proof of a user's expertise in a particular subject matter area; and (16) other proof that a user is a genuine person who is associated with other genuine users, as well as other proof of user's other activity and other proof of user's expertise, etc.

General activity of object 101 may include how much and how frequently object information 102 is added to object 101. General activity of a user may include how much and how frequently the user is adding new objects 101 and object information 102. General activity of a user may further include how much and how frequently the user's associated users are adding new objects 101 and object information 102. General activity of a user may include anything that the user is able to do on site 145 or any website.

In one aspect, the genuineness of a user may be further verified by confirming one or more of the following: (a) that the Internet Protocol (IP) address of the user is registered to a valid Internet Service Provider (ISP) (b) that the user is not accessing site 145 from a commercial server or proxy server; (b) checking the amount of users logged in with the user's IP address or IP addresses within close proximity to the user's IP address or from where the user's IP address originates; (c) determining whether the user's IP address is on a blacklist for SPAM; (d) determining if the user is flagged as having submitted advertisements on site 145; and (e) using human verification techniques, such as having the user type text displayed in an image or a Turing image or played in a sound file.

In another aspect, a user may be able to rate an object 101 while a user adds the object 101, or after the object 101 has been added. In further aspects, a user may have the opportunity when rating a previously-rated object 101 to add or suggest more object information 102, or view and rate other users' object information 102 for that object 101.

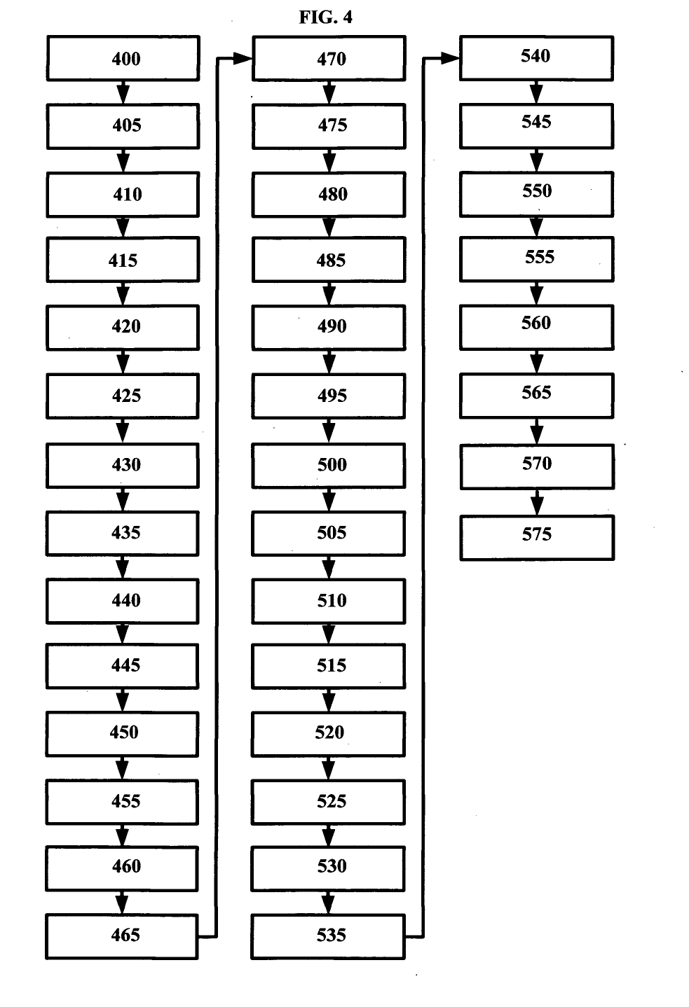

As shown in FIG. 4 according to one aspect of the present invention, at step 400, the one or more host servers 150 receives instructions or commands that three users 98 of user type 95, User1, User2, and User3 viewed an object 101. In this example, object 101 is the first link in a particular search result that was effected by User1's, User2's, and User3's use of the same search terms “2010 NBA Finals” on site 145 and retrieved from one or more databases 190 or other sites connected to site 145 through network 140 or cellular network 130. Object 101 was previously unrated.

At step 405, User1 assigns a rating to object 101 of 9/10 based on the relevance of the search term to the content found on the link in the search results. For the same reason, User2 assigns a rating to object 101 of 9/10 and User3 assigns a rating to object 101 of 5/10. Each one of these ratings may be stored in one or more databases 190. In this example, User1, User2, and User3 have not previously rated objects designated by site 145, or other users.

At step 410, the one or more host servers 150 access the one or more databases 190 to retrieve User1's, User2's, and User3's user ratings. In this aspect, hypothetically, User1, User2, and User3 each have a user rating of 100/100.

At step 415, the one or more host servers 150 calculate the object rating of object 101. In this example, the object rating of object 101 would be an average of the ratings from User1, User2, and User3. As such, object 101's object rating would be computed as follows: ((90+90+50)÷3)/100=76.6667/100. Because each of the users had the same user rating, each of User1's, User2's, and User3's rating for object 101 had the same degree of impact on the object rating of object 101.

At step 420, the one or more host servers 150 store the object rating of object 101 in one or more databases 190.

At step 425, the one or more host servers 150 calculate the user ratings of User1, User2, and User3. In this example, a user rating is recalculated by comparing the rating assigned to object 101 by that user with the ratings assigned to object 101 by all of the other users, while taking into consideration the original user ratings of each of those other users. This recalculation may be performed to recalculate each user's user rating.

In this example, User1, User2, and User3 each rated object 101 with the same beginning user rating of 100/100, so they all affect object 101 equally and, thus, their user ratings will be recalculated equally. User1 assigned object 101 a rating of 9/10. With respect to User1, the other users, User2 and User3, respectively, assigned object 101 a rating of 9/10 and 5/10, which calculates to an average rating of 7/10 (calculations: ((9+5)÷2)/10). Once the average rating is calculated, the percentage difference between the rating User1 assigned to object 101 and the rating the other users assigned to object 101 is calculated by making User1's rating equal to 100% and determining what percentage the other users', User2's and User3's, average rating would be (calculations (in percentages): 70×100÷90=77.7778%). In other words, for calculation purposes, User1's 90/100 rating is assumed to be 100/100 and then, under this assumption, the calculation determines by what percentage the other users' average rating of 70 differs from User1's rating. In this example, a 22.2222% difference between User1's rating and the other users' average rating of object 101 is calculated (calculation: 100%−77.7778%=22.2222%). In other words, the average percentage disagreement is 22.2222%. User1's overall user rating is thus calculated as 77.7778%. Similarly, User1's specific user rating relating to search, or “search related specific user rating”, is thus calculated as 77.7778%. In one aspect, a user's search related specific user rating is associated to all search results from the specific terms used in the search. In another aspect, a user's search related specific user rating is associated to all search results from terms similar to those used in the search. In yet another aspect, a user's search related specific user rating is associated to all searches.

Further to this example, User2's average percentage disagreement would also be 22.2222%, which would result in User2's overall user rating of 77.7778% and search related specific user rating of 77.7778%. This calculation is derived in the following manner. User2 assigned object 101 a rating of 9/10. With respect to User2, the other users, User1 and User3, respectively, assigned object ratings of 9/10 and 5/10, which calculates to an average rating of 7/10 (calculations: ((9+5)÷2)/10). Once the average rating is calculated, the percentage difference between the rating User2 assigned to object 101 and the rating the other users assigned to object 101 is calculated by making User2's rating equal to 100% and determining what percentage the other users', User1's and User3's, average rating would be (calculations (in percentages): 70×100÷90=77.7778%). In other words, for calculation purposes, User2's 90/100 rating is assumed to be 100/100 and then, under this assumption, the calculation determines by what percentage the other users' average rating of 70 differs from User2's rating. In this example, a 22.2222% difference between User2's rating and the other users' average rating of object 101 is calculated (calculation: 100%−77.7778%=22.2222%). In other words, the average percentage disagreement is 22.2222%. User2's overall user rating and search related specific user rating are thus calculated as 77.7778% and 77.7778%, respectively.

Further to this example, User3's average percentage disagreement would be 44.4444%, which would result in User3's overall user rating of 55.5556% and search related specific user rating of 55.5556%. This calculation is derived in the following manner. User3 assigned object 101 a rating of 5/10. With respect to User3, the other users, User1 and User2, respectively, assigned object ratings of 9/10 and 9/10, which calculates to an average rating of 9/10 (calculations: ((9+9)÷2)/10). Once the average rating is calculated, the percentage difference between the rating User3 assigned to object 101 and the rating the other users assigned to object 101 is calculated by making the other users' average rating equal to 100% and determining what percentage User3's rating would be (calculations (in percentages): 50×100÷90=55.5556%). In this example, user ratings are calculated based on the largest rating, and here, the other users, User1 and User2, have the largest rating. In other words, the other users' 90/100 average rating is assumed to be 100/100 and then, under this assumption, the calculation determines by what percentage User3's rating of 50/100 differs from the other users' average rating. In this example, a 44.4444% difference between User3's rating and the other users' average rating of object 101 is calculated (calculation: 100%−55.5556%=44.4444%). In other words, the average percentage disagreement is 44.4444%. User3's overall user rating and search related specific user rating are thus calculated as 55.5556% and 55.5556%, respectively.

At step 430, User1's, User2's, and User3's overall user ratings and specific user ratings are stored in one or more databases 190.

Further to this example, at step 435, the one or more host servers 150 receive instructions or commands that User1, User2, and User3 viewed a different object 101 than in step 400. Here, object 101 is a different link that resulted from the same search as in step 400. At step 440, User1 assigns a rating to object 101 of 9/10 based on the relevance of the search term to the content found on the link in the search results. For the same reason, User2 assigns a rating to object 101 of 9/10 and User3 assigns a rating to object 101 of 9/10. Each one of these ratings may be stored in one or more databases 190.

At step 445, the one or more host servers 150 access the one or more databases 190 to retrieve User1's, User2's, and User3's user ratings. In this example, User1 has an overall user rating of 77.7778% and a search related specific user rating of 77.7778%; User2 has an overall user rating of 77.7778% and a search related specific user rating of 77.7778%; and User3 has an overall user rating of 55.5556% and a search related specific user rating of 55.5556%.

At step 450, the one or more host servers 150 calculate the object rating of object 101. Because at least one of User1, User2, and User3 has a different user rating, their object ratings will not have the same degree of impact on the object rating of object 101. Object 101's object rating is 90/100. This calculation is derived as follows. The sum of User1's, User2's, and User3's user ratings is calculated (calculation: (77.7778+77.7778+55.5556)=211.1112). The weight of each of User1's, User2's, and User3's rating power in comparison with that of the other users is calculated (calculations: [User1 weight=77.7778×100÷211.1112=36.8421%]; [User2 weight=77.7778×100÷211.1112=36.8421%]; [User3 weight=55.5556×100÷211.1112=26.3158%]). The weight each of User1's, User2's, and User3's rating of object 101 will have on object 101's object rating is calculated (calculations: [User1 weight=90×36.8421÷100=33.1579%]; [User2 weight 90×36.8421÷100=33.1579%]; [User3 weight=90×26.3158÷100=23.6842%]). The sum of the weights is determined, which equals the new object rating of object 101 (calculations: 33.1579%+33.1579%+23.6842%=90%).

At step 455, the one or more host servers 150 store the object rating of object 101 in one or more databases 190.

At step 460, the one or more host servers 150 calculate the user ratings of User1, User2, and User3. In this example, a user rating is recalculated by comparing the rating assigned to object 101 by that user with the ratings assigned to object 101 by all of the other users, while taking into consideration the original user ratings of each of those other users. This recalculation may be performed to recalculate each user's user rating.

In this example, User1, User2, and User3 each assigned object 101 a rating of 9/10, therefore, with respect to User1, the other users, User2 and User3, had assigned object 101 an average rating of 90% (calculations: ((9+9)÷2)/10). The percentage difference between the object rating User1 assigned to object 101 and the rating the other users assigned to object 101 is calculated by making User1's rating equal to 100% and determining what percentage the other users', User2's and User3's, average rating would be (calculations: (90×100÷90=100%). Accordingly, in this example, there is a 0% difference between User1's rating and the other users' combined ratings of object 101 (calculation: 100%−100%=0%). In calculating the user rating of User1, User1's other object ratings may also be taken into consideration. For example, assuming User1 only made one other object rating—the one made at step 405—(for a total of two object ratings), the percentage difference between User1's ratings and the other users' ratings will be calculated and averaged (calculations: (22.2222%+0%)÷2=11.1111%). In this example, because there was no difference between what the users rated the other object 101, the average percentage disagreement is now 11.1111%, which leads to a user rating of 88.8889 of User1 (calculations: 100%−11.1111%=88.8889%). As a result, User1's overall user rating is 88.8889% and search related specific user rating is 88.8889%.

Further to this example, User2 assigned the object rating of 9/10 to object 101, therefore, with respect to User2, the other users, User1 and User3, had assigned object 101 an average rating of 90% (calculations: ((9+9)÷2)/10). The percentage difference between the object rating User2 assigned to object 101 and the rating the other users assigned to object 101 is calculated by making User2's rating equal to 100% and determining what percentage the other users', User1's and User3's, average rating would be (calculations: (90×100÷90=100%). Accordingly, in this example, there is a 0% difference between User2's rating and the other users' combined ratings of object 101 (calculation: 100%-100%=0%). In calculating the user rating of User2, User2's other object ratings may also be taken into consideration. For example, assuming User2 only made one other object rating—the one made at step 405—(for a total of two object ratings), the percentage difference between User2's ratings and the other users' ratings will be calculated and averaged (calculations: (22.2222%+0%)÷2=11.1111%). In this example, because there was no difference between what the users rated the other object 101, the average percentage disagreement is now 11.1111%, which leads to a user rating of 88.8889 of User2 (calculations: 100%−11.1111%=88.8889%). As a result, User2's overall user rating is 88.8889% and search related specific user rating is 88.8889%.

Further to this example, User3 assigned the object rating of 9/10 to object 101, therefore, with respect to User3, the other users, User1 and User2, had assigned object 101 an average rating of 90% (calculations: ((9+9)÷2)/10). The percentage difference between the object rating User3 assigned to object 101 and the rating the other users assigned to object 101 is calculated by making User3's rating equal to 100% and determining what percentage the other users', User1's and User2's, average rating would be (calculations: (90×100−90=100%). Accordingly, in this example, there is a 0% difference between User3's rating and the other users' combined ratings of object 101 (calculation: 100%−100%=0%). In calculating the user rating of User3, User3's other object ratings may also be taken into consideration. For example, assuming User3 only made one other object rating—the one made at step 405—(for a total of two object ratings), the percentage difference between User3's ratings and the other users' ratings will be calculated and averaged (calculations: (44.4444%+0%)=22.2222%). In this example, because there was no difference between what the users rated the other object 101, the average percentage disagreement is now 22.2222%, which leads to a user rating of 77.7778 of User3 (calculations: 100%−22.2222%=77.7778%). As a result, User3's overall user rating is 77.7778% and search related specific user rating is 77.7778%.

At step 465, User1's, User2's, and User3's overall user ratings and specific user ratings are stored in one or more databases 190.

Further to this example, at step 470, the one or more host servers 150 receive instructions or commands that User1, User2, and User3 viewed a different object 101 than in steps 400 and 435. Here, object 101 is a different link that resulted from the same search as in steps 400 and 435. At step 475, User1 assigns a rating to object 101 of 10/10 based on the relevance of the search term to the content found on the link in the search results. For the same reason, User2 assigns a rating to object 101 of 9/10 and User3 assigns a rating to object 101 of 6/10. Each one of these ratings may be stored in one or more databases 190.

At step 480, the one or more host servers 150 access the one or more databases 190 to retrieve User1's, User2's, and User3's user ratings. In this example, User1 has an overall user rating of 88.8889% and a search related specific user rating of 88.8889%; User2 has an overall user rating of 88.8889% and a search related specific user rating of 88.8889%; and User3 has an overall user rating of 77.7778% and a search related specific user rating of 77.7778%.

At step 485, the one or more host servers 150 calculate the object rating of object 101. Because at least one of User1, User2, and User3 has a different user rating, their object ratings will not have the same degree of impact on the object rating of object 101. Object 101's object rating is 84.3478/100. This calculation is derived as follows. The sum of User1's, User2's, and User3's user ratings is calculated (calculation: (88.8889+88.8889+77.7778)=255.5556). The weight of each of User1's, User2's, and User3's rating power in comparison with that of the other users is calculated (calculations: [User1 weight=88.8889×100÷255.5556=34.7826%]; [User2 weight=88.8889×100÷255.5556=34.7826%]; [User3 weight=77.7778×100+255.5556=30.4348%]). The weight each of User1's, User2's, and User3's rating of object 101 will have on object 101's object rating is calculated (calculations: [User1 weight=100×34.7826÷100=34.7826%]; [User2 weight 90×34.7826÷100=31.3043%]; [User3 weight=60×30.4348÷100=18.2609%]). The sum of the weights is determined, which equals the new object rating of object 101 (calculations: 34.7826%+31.3043%+18.2609%=84.3478%).

At step 490, the one or more host servers 150 store the object rating of object 101 in one or more databases 190.

At step 495, the one or more host servers 150 calculate the user ratings of User1, User2, and User3.

In this example, User1 assigned object 101 a rating of 10/10, therefore, with respect to User 1, the other users, User2 and User3, had assigned object 101 an average rating of 76%. The sum of the other users' user ratings is determined to be 166.6667% (calculations: 88.8889%+77.7778%=166.6667%). The user weights with respect to their object ratings of User2 and User3 are now calculated (calculations: [User2: 88.8889×100÷166.6667=53.3333%]; [User3: 77.7778×100÷166.6667=46.6667%]). Based on the user weights, the impact their weight will have on the object rating is calculated (calculations: [User2: 90×53.3333÷100=48.0000%]; [User3: 60×46.6667÷100=28.0000%]). The sum of these ratings is determined to be 76.0000% (calculations: 48%+28%=76%).

The percentage difference between the object rating User1 assigned to object 101 and the rating the other users assigned to object 101 is calculated by making User1's rating equal to 100% and determining what percentage the other users', User2's and User3's, average rating would be (calculations: 76×100÷100=76%). Accordingly, in this example, there is a 24% difference between User 1's rating and the other users' combined ratings of object 101 (calculations: 100%−76%=24%). The sum of the weights of User2 and User3 is calculated (calculations: 34.7826%+30.4348%=65.2174%). As a result, the other users' combined weight of 65.2174% may only affect the difference of 24% proportionally (calculations: 24×65.2174÷100=15.6522%). Consequently, 65.2174% of the 24% difference weighs against User1, i.e., 15.6522%.

In further calculating the user rating of User1, User 1's other object ratings may also be taken into consideration. For example, assuming User1 only made two other object ratings (at steps 405 and 435), the percentage difference between User1's ratings and the other users' ratings will be calculated and averaged (calculations: (22.2222%+0%+15.6522%)÷3=12.6248%). In this example, the average percentage disagreement is now 12.6248%, which leads to an overall user rating of 87.3752% of User1 (calculations: 100%−12.6248%=87.3752%). As a result, User1's overall user rating is 87.3752% and search related specific user rating is 87.3752%. User2's overall user rating would be similarly calculated to be 90.4992% and User2's search related specific user rating would be similarly calculated to be 90.4992%. In determining User3's ratings, the other users' average rating are made to equal to 100% (instead of User3's rating). Thus, User3's overall user rating would be similarly calculated to be 76.6421% and User3's search related specific user rating would be similarly calculated to be 76.6421%.

At step 500, User1's, User2's, and User3's overall user ratings and specific user ratings are stored in one or more databases 190.

Further to this example, at step 505, the one or more host servers 150 receive instructions or commands that User1, User2, and User3 viewed a different object 101 in a different area of the site than search in steps 400, 435, and 470. Here, object 101 is recent news that was posted in the “Basketball” section of site 145. At step 510, User1 assigns a rating to object 101 of 9/10 based on the relevance of the recent news post to the “Basketball” section of the site. For the same reason, User2 assigns a rating to object 101 of 8/10 and User3 assigns a rating to object 101 of 6/10. Each one of these ratings may be stored in one or more databases 190.

At step 515, the one or more host servers 150 access the one or more databases 190 to retrieve User1's, User2's, and User3's user ratings. In this example, User1 has an overall user rating of 87.3752% and a search related specific user rating of 87.3752%; User2 has an overall user rating of 90.4992% and a search related specific user rating of 90.4992%; and User3 has an overall user rating of 76.6421% and a search related specific user rating of 76.6421%.

At step 520, the one or more host servers 150 calculate the object rating of object 101. Because User1, User2, and User3 have different user ratings, their object rating will not have the same degree of impact on the object rating of object 101. Object 101's object rating is 77.4104/100. This calculation is derived as follows. The sum of User1's, User2's, and User3's overall user ratings is calculated (calculation: (87.3752%+90.4992%+76.6421%)=254.5165%). The weight of each of User1's, User2's, and User3's rating power in comparison with that of the other users is calculated (calculations: [User1 weight=87.3752×100÷254.5165=34.3299%]; [User2 weight=90.4992×100÷254.5165=35.5573%]; [User3 weight=76.6421×100÷254.5165=30.1128%]). The weight each of User1's, User2's, and User3's rating of object 101 will have on object 101's object rating is calculated (calculations: [User1 weight=90×34.3299÷100=30.8969%]; [User2 weight=80×35.5573÷100=28.4458%]; [User3 weight=60×30.1128÷100=18.0677%]). The sum of the weights is determined, which equals the new object rating of object 101 (calculations: 30.8969%+28.4458%+18.0677%=77.4104%).

At step 525, the one or more host servers 150 store the object rating of object 101 in one or more databases 190.

At step 530, the one or more host servers 150 calculate the user ratings of User1, User2, and User3.

In this example, User1 assigned object 101 a rating of 9/10, therefore, with respect to User1, the other users, User2 and User3, had assigned object 101 an average rating of 70.8290%. The sum of the other users' user ratings is determined to be 167.1413% (calculations: 90.4992%+76.6421%=167.1413%). The user weights with respect to their object ratings of User2 and User3 are now calculated (calculations: [User2: 90.4992×100÷167.1413=54.1453%]; [User3: 76.6421×100÷167.1413=45.8547%]). Based on the user weights, the impact their weight will have on the object rating is calculated (calculations: [User2: 80×54.1453÷100=43.3162%]; [User3: 60×45.8547÷100=27.5128%]). The sum of these ratings is determined to be 70.8290% (calculations: 43.3162%+27.5128%=70.8290%).

The percentage difference between the object rating User1 assigned to object 101 and the rating the other users assigned to object 101 is calculated by making User1's rating equal to 100% and determining what percentage the other users', User2's and User3's, average rating would be (calculations: (70.8290×100÷90=78.6989%). Accordingly, in this example, there is a 21.3011% difference between User1's rating and the other users' combined ratings of object 101 (calculations: 100%−78.6989%=21.3011%). The sum of the weights of User2 and User3 is calculated (calculations: 35.5573%+30.1128%=65.6701%). As a result, the other users' combined weight of 65.6701% may only affect the difference of 21.3011% proportionally (calculations: 21.3011×65.6701÷100=13.9885%). Consequently, 65.6701% of the 21.3011% difference weighs against User1, i.e., 13.9885%.

In further calculating the user rating of User1, User1's other object ratings may also be taken into consideration. For example, assuming User1 only made three other object ratings (at steps 405, 435, and 475), the percentage difference between User1's ratings and the other users' ratings will be calculated and averaged (calculations: (22.2222%+0%+15.6522%+13.9885%)+4=12.9657%). In this example, the average percentage disagreement is now 12.9657%, which leads to an overall user rating of 87.0343% of User1 (calculations: 100%-12.9657%=87.0343%). As a result, User1's overall user rating is 87.0343%. User1's specific user rating would depend on the specific user rating in question. For example, User1's search related specific user rating would remain 87.3752%, but the Basketball related specific user rating would be 86.0115% (calculations: 100%-13.9885%=86.0115%). User2's overall user rating would be similarly calculated to be 92.0651%, User2's search related specific user rating would remain 90.4992% and User2's Basketball related specific user rating would be similarly calculated to be 96.7630%. In determining User3's ratings, the other users' average rating are made to equal to 100% (instead of User3's rating). Thus, User3's overall user rating would be similarly calculated to be 77.3555%, User3's search related specific user rating would remain 76.6421% and User3's Basketball related specific user rating would be similarly calculated to be 79.4959%.

At step 535, User1's, User2's, and User3's overall user ratings and specific user ratings are stored in one or more databases 190.

At step 540, periodically, on a given event, or in real-time, site 145 may decrease any user's user rating if a user's activity signals that the user may not be objectively rating objects, or may decrease any user's user rating for reasons described above.

In this example, User4 joins site 145. User4 is a user 98 of user type 95 and begins with an overall user rating of 100%. User4 accessed the site from a proxy server Internet Protocol (IP) address, which decreases User4's overall user rating by 40% (calculation: 100%−40%=60%). User4 only has five (5) associated users in the first degree. Because User4 has less than ten (10) associated users in the first degree, User4's overall user rating is decreased by an additional 20% from the overall user rating of 100% (calculation: 100%−(40%+20%)=100%−60%=40%). User4's associated users in the first degree do not have any associated users themselves, which causes User4's overall user rating to be decreased by an additional 20% (calculation: 100%−(40%+20%+20%)=100%−80%=20%). In addition, User4's general activity on site 145 has been low, as User4 has only logged into site 145 two (2) times and has not used its homepage 99 (including User4's photo section and video section) for any posts or uploads, including posts or uploads of objects 101, nor has User4 posted or uploaded anything, including objects 101, anywhere on site 145. As a result, User4's overall user rating is decreased by an additional 15% (calculation: 100%−(40%+20%+20%+15%)=100%−95%=5%). User4's overall user rating is 5%.

At step 545, the one or more host servers 150 receive instructions or commands that User1, and User2 viewed a different object 101 than in steps 400, 435, 470, and 505, and that User4 viewed this object as well. Here, object 101 is a different recent news post that was posted in the “Basketball” section of site 145. At step 550, User1 assigns a rating to object 101 of 10/10 based on the relevance of the recent news post to the “Basketball” section of the site. For the same reason, User2 assigns a rating to object 101 of 10/10 and User4 assigns a rating to object 101 of 0/10. Each one of these ratings may be stored in one or more databases 190.

At step 555, the one or more host servers 150 access the one or more databases 190 to retrieve User1's, User2's, and User4's user ratings. In this example, User1 has an overall user rating of 87.0343%, a search related specific user rating of 87.3752% and a Basketball related specific user rating of 86.0115%; User2 has an overall user rating of 92.0651%, a search related specific user rating of 90.4992% and a Basketball related specific user rating of 96.7630%; and User4 has an overall user rating of 5%. In other aspects, the Basketball related specific user ratings may be related specifically to the Basketball section of site 145.

At step 560, the one or more host servers 150 calculate the object rating of object 101. The object rating is calculated to be 97.3020%. The calculation is derived as follows. In this example, because two of the users that rated object 101 have already rated one or more objects 101 in the Basketball section, their overall user rating must be recalculated excluding their Basketball related specific user rating and making this new overall user rating equal to 50% of that user rating. Their current Basketball related specific user rating is also made equal to 50% of that user rating. Then, the sum of these two calculations yields a users' new overall-specific user rating, which may be only used in the Basketball section, and which affects the next ratings made in the Basketball section. This recalculation may give the users who have already rated objects 101 in the Basketball section more weight in rating further objects 101 in that section, which may be a specialty area for that user, while still taking into consideration the other activity associated with the user on site 145, as exemplified in the user's overall user rating.

User1 made four other ratings for an object 101, and one rating was for the Basketball section, which is omitted in calculating the new overall user rating because the new overall user rating is only used in the Basketball section. Only the other ratings User1 made are included to calculate User1's new overall user rating in the Basketball section. Thus, the percentage difference between User1's ratings and the other users' ratings is averaged: (calculation: 22.2222%+0%+15.6522%÷ 3=12.6248%). The average percentage disagreement is now 12.6248%. User1 now has an overall user rating in the Basketball section of 87.3752% (calculation: 100%−12.6248%=87.3752%), and 50% of that user rating is 43.6876% (calculation: 87.3752%÷2=43.6876%). User1 has a Basketball related specific user rating of 86.0115%, and 50% of that user rating is 43.0058% (calculation: 86.0115%÷2=43.0058%). The sum of the two user ratings yields the new overall-specific user rating which may be only used in the Basketball section, and which may affect anything User1 does in the Basketball section. The new overall-specific user rating is 86.6934% (calculation: 43.2496%+43.0058%=86.6934%).

User2 made four other ratings for an object 101, and one rating was for the Basketball section, which is omitted in calculating the new overall user rating because the new overall user rating is only used in the Basketball section. Only the other ratings User2 made are included to calculate User2's new overall user rating in the Basketball section. Thus, the percentage difference between User2's ratings and the other users' ratings is averaged: (calculation: 22.2222%+0%+6.2802%+3=9.5008%). The average percentage disagreement is now 9.5008%. User2 now has an overall user rating in the Basketball section of 90.4992% (calculation: 100%−9.5008%=90.4992%), and 50% of that user rating is 45.2496% (calculation: 90.4992%+2=45.2496%). User2 has a Basketball related specific user rating of 96.7630%, and 50% of that user rating is 48.3815% (calculation: 96.7630%+2=48.3815%). The sum of the two user ratings yields the new overall-specific user rating, which may be only used in the Basketball section, and which may affect anything User2 does in the Basketball section. The new overall-specific user rating is 93.6311% (calculation: 45.2496%+48.3815%=93.6311%).

User4 has not made any other ratings and has an overall user rating of 5%.

At step 565, the one or more host servers 150 calculate the object rating of object 101. Because User1, User2, and User4 have different user ratings, their object rating will not have the same degree of impact on the object rating of object 101. Object 101's object rating is 97.3020/100. This calculation is derived as follows. The sum of User1's and User2's new overall-specific user ratings which is only used in the Basketball section, and User4's overall user rating is calculated (calculation: (86.6934%+93.6311%+5%)=185.3245%). The weight of each of User1's, User2's, and User4's rating power in comparison to that of the other users is calculated (calculations: [User1 weight=86.6934×100÷185.3245=46.7792%]; [User2 weight=93.6311×100÷185.3245=50.5228%]; [User4 weight=5×100÷185.3245=2.6980%]). The weight each of User1's, User2's, and User4's rating of object 101 will have on object 101's object rating is calculated (calculations: [User1 weight=100×46.7792÷100=46.7792%]; [User2 weight=100×50.5228÷100=50.5228%]; [User4 weight=0×2.6980÷100=0%]). The sum of the weights is determined, which equals the new object rating of object 101 (calculations: 46.7792%+50.5228%+0%=97.3020%).

At step 570, the one or more host servers 150 store the object rating of object 101 in one or more databases 190.

At step 575, the one or more host servers 150 calculate the user ratings of User1, User2, and User4.

In this example, User1 assigned object 101 a rating of 10/10, therefore, with respect to User1, the other users, User2 and User4, had assigned object 101 an average rating of 94.9306%. The sum of the other users' user ratings is determined to be 98.6311% (calculations: 93.6311%+5%=98.6311%). The user weights with respect to their object ratings of User2 and User4 are now calculated (calculations: [User2: 93.6311×100÷98.6311=94.9306%]; [User4: 5×100÷98.6311=5.0694%]). Based on the user weights, the impact their weight will have on the object rating is calculated (calculations: [User2: 100×94.9306÷100=94.9306%]; [User4: 0×5.0694÷100=0%]). The sum of these ratings is determined to be 94.9306% (calculations: 94.9306%+0%=94.9306%).

The percentage difference between the object rating User1 assigned to object 101 and the rating the other users assigned to object 101 is calculated by making User1's rating equal to 100% and determining what percentage the other users', User2's and User4's, average rating would be (calculations: (94.9306×100÷100=94.9306%). Accordingly, in this example, there is a 5.0694% difference between User1's rating and the other users' combined ratings of object 101 (calculations: 100%−94.9306%=5.0694%). The sum of the weights of User2 and User4 is calculated (calculations: 50.5228%+2.6980%=53.2208%). As a result, the other users' combined weight of 53.2208% may only affect the difference of 5.0694% proportionally (calculations: 5.0694×53.2208÷100=2.6980%). Consequently, 53.2208% of the 5.0694% weighs against User1, i.e., 2.6980%.

In further calculating the user rating of User1, User1's other object ratings may also be taken into consideration. For example, assuming User1 only made four other object ratings (at steps 405, 435, 475 and 510), the percentage difference between User1's ratings and the other users' ratings will be calculated and averaged (calculations: (22.2222%+0%+15.6522%+13.9885+2.6980%)÷5=10.9122%). In this example, the average percentage disagreement is now 10.9122%, which leads to an overall user rating of 89.0878% for User1 (calculations: 100%−10.9122%=89.0878%). User1's specific user rating would depend on the specific user rating in question. For example, User1's search related specific user rating would remain 87.3752%. However, with respect to the Basketball related specific user rating, assuming User1 only made one other object rating in the Basketball section (at step 510), the percentage difference between User1's ratings and the other users' ratings will be calculated and averaged (calculations: (13.9885%+2.6980%)÷2=8.3433%). In this example, the average percentage disagreement is 8.3433%, which leads to a Basketball related specific user rating of 91.6567% of User1 (calculations: 100%−8.3433%=91.6567%). As a result, User1's Basketball related specific user rating is 91.6567%. User2's overall user rating would be similarly calculated to be 93.1125%, User2's search related specific user rating would remain 90.4992% and User2's Basketball related specific user rating would be similarly calculated to be 97.0325%. In determining User4's ratings, the other users' average rating are made to equal to 100% (instead of User4's rating). Thus, User4's overall user rating would be similarly calculated to be 2.6980%, User4 does not have a search related specific user rating and User4's Basketball related specific user rating would be similarly calculated to be 2.6980%.

There may be several additions or variations to the ratings system. Certain search terms may be rated separately from other search terms in the same search, as opposed to grouping the separate search terms and rating the group of terms as a whole. There may also be additional sections on site 145 or on other websites that have ratings separate from the ones described above.

For User3 and User4, the calculations vary slightly because for these users, the percentage difference is calculated from the largest rating, as mentioned above. In the above example, User1 and User2 have the largest ratings. An alternate calculation may be performed by calculating the percentage difference between the object rating User3 or User4 assigned to object 101 and the rating the other users assigned to object 101 by making User3 or User4's rating equal to 100% and determining what percentage the other users', User1's and User2's, average rating would be as described for both User1 and User2, and subtracting 100% from that number to attain a higher percentage difference.

Additionally, it may be possible to incorporate percentages and absolute value differences, or alternatively only absolute value differences, rather than solely the percentage difference in determining ratings.

In one aspect, a user who posts objects and rates objects may be provided a higher user rating than a user who merely rates objects, but does not post objects to site 145.

In another aspect, a user who agrees with the highest or lowest rated object by also rating it high or low in order to manipulate his or her user rating may not gain a higher user rating. Such attempts to manipulate user ratings may be prevented or obstructed by prohibiting the user from viewing an object's rating, from rating an object after a designated amount of time after the object has posted, or from rating an object after the object has received a designated minimum amount of object ratings. In another aspect, if a certain amount of users with better than a certain user rating (for example, 70% user rating) rate an object, then other users may not be able to rate the object. In another aspect, if users are not able to rate an object for reasons described above, it may still be possible for the object to be rated at a later designated time or after the occurrence of a certain event. In such a case, benefits associated with additional ratings may facilitate fairness in the object's rating.

In one aspect, if a user rates an object by merely agreeing with other users who already rated the object, then the rating that the user gave the object may not affect the users' user rating. In another aspect, if the user disagrees with the other, users to a designated amount, then the users' user rating may be negatively affected. In this manner, a user may not be able to manipulate their user rating by merely agreeing with other users, for example, to achieve a higher user rating. This may be established after a designated amount of time passes after the object posts or after the object has received certain amount of object ratings.

Ratings of objects may be based on quality with the same rating process as with the other parts of object information as outlined above.

In the above examples, calculating ratings such as the overall-specific user rating utilized a predefined percentage of 50%. However, other percentages may be used (for example, to provide alternate weighing of ratings). Similarly, the same applies to other areas of calculations for user ratings, object ratings and in the user ratings deductions made for User4 in the above examples.

The calculations presented above do not limit aspects of the present invention, and variations exist that may bring similar and/or fair results.

In another aspect, a user may add objects and/or object information to a site or sites from a program installed in his or her browser. A user has the ability to download a program onto their computer that becomes part of the browser window. Through this program the user will have options to assign object information about the page, or about any object(s) on the page that the user is currently on in the browser window. This object information may or may not include a rating. This is all completed through the program installed in the browser. The user may assign the page or any object(s) on the page to one or more sections of a particular site or any site(s), and what the user assigns may then appear in that section or sections of the site or any site(s). In one aspect, a user may assign the page or any object(s) on the page to the basketball section of the site in the basketball subsection: recent news, basketball subsection: wiki, as well as the NY Knicks section of the site in the NY Knicks subsection: recent news, NY Knicks subsection: wiki. When a user chooses to assign object information to object(s) on the page through the program in the browser, they may assign object information about just one object at a time or many objects at a time. In one aspect, the user will be able to highlight and/or click any type of object(s) on the page in the browser that the user wants to assign object information about and the program installed in the browser will allow the user to assign object information about the highlighted and/or clicked object. In another aspect, the editing features of the program may be separate from the browser window but still be connected to the activity in the browser window. In another aspect, all the features of the program may inherently be part of a site or sites without the need to install the program.

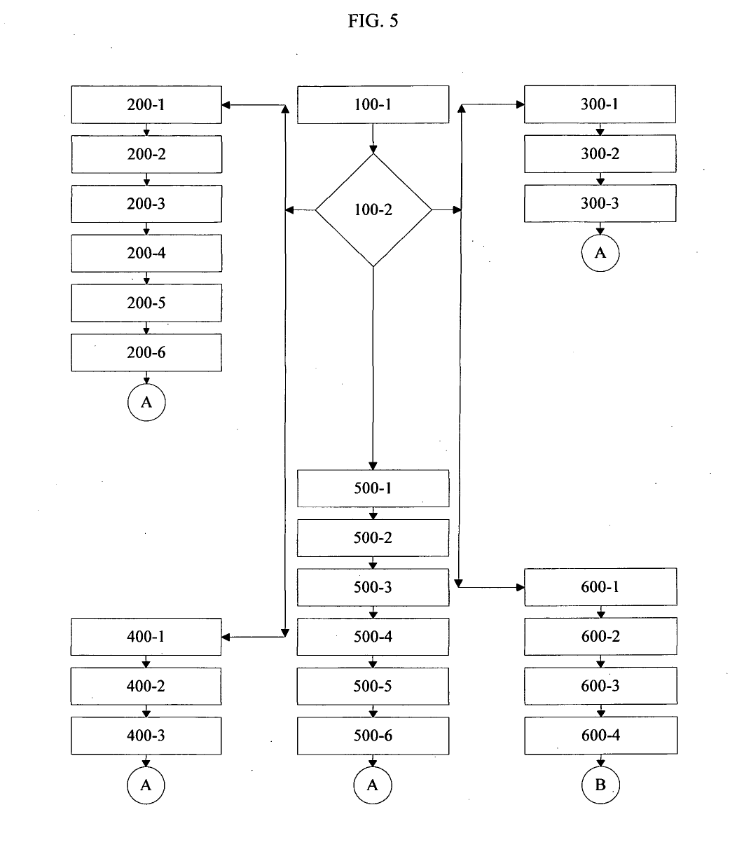

FIG. 5 illustrates a method according to another aspect of the present invention. As shown in FIG. 5, at step 100-1, according to one aspect of the present invention, the one or more host servers 150 may receive data from computing systems 115, 110, and/or 120 inputted by a user 98. Such data may include instructions or commands for the one or more host servers 150 to log user into site 145. At step 100-2, if such data is to log user into site 145 and the login data is correct, then the user 98's homepage 99 loads and all updates appear from all of the user 98's associated users, from all of the user 98's links and from all of the user 98's interests on the user 98's homepage 99; each of which may contain object information 102. Data may now also include instructions or commands for the one or more host servers 150 to, for example: (1) add one or more objects 101, both in the form of links, as well as assign object information 102, in the links section of the user 98's homepage 99, show or hide any or all of the objects 101 manually added or imported to the user 98's link section on the user 98's homepage 99 from other users who may be on the user 98's homepage 99 and order the objects 101 according to the user 98's preferences; (2) assign object information 102 to an object 101, as well as add an object 101, on any page on site 145 or any website; (3) comment on, reply to, add one or more objects 101 or assign object information 102 to any objects 101 that appear in the updates section of the user 98's homepage 99, the homepages of the associated users of one or more degrees to the user 98 or other users' homepages 99; (4) set preferences to determine which updates the user 98 sees on the user 98's homepage 99; (5) set privacy settings to determine which updates other users may see on the user 98's homepage 99 as well as set privacy settings to determine which updates from the user 98's activity appear on other users homepages 99; (6) add one or more objects 101, as well as assign object information 102, on any page on site 145 or any website; (7) perform a search on site 145 and World Wide Web from the front page, homepage 99, or any page on site 145, or any website using a search term.

After step 100-2, the method shown in FIG. 5 may proceed to any of steps 200-1, 300-1, 400-1, 500-1, or 600-1, depending on the instruction or command received by the one or more host servers 150.

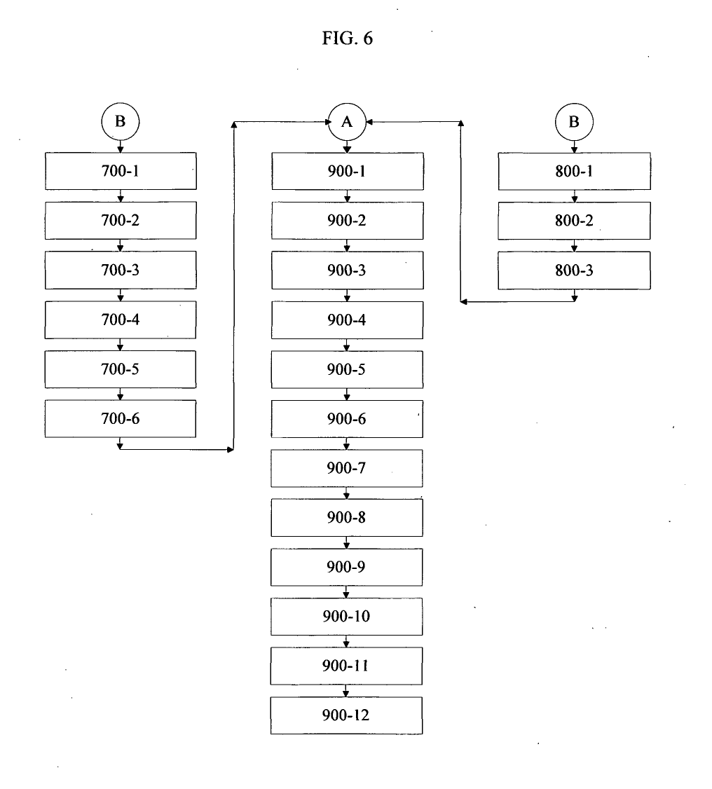

According to the method in FIG. 5, the user 98 may add one or more objects 101, both in the form of links, as well as assign object information 102, in the links section of the user 98's homepage 99, show or hide any or all of the objects 101 manually added or imported to the user 98's link section on the user 98's homepage 99 from other users who may be on the user 98's homepage 99 and order the objects 101 any way the user likes. At step 200-1, the one or more host servers 150 receive data inputted by the user 98 and determine whether the data includes commands or instructions to add one or more objects 101 manually or by importing favorites and/or bookmarks in the links section of the user 98's homepage 99. At step 200-2, responsive to determining that the data includes commands or instructions to add one or more objects 101 manually or by importing favorites and/or bookmarks in the links section of the user 98's homepage 99, the one or more host servers 150 may add the one or more objects 101 manually or by importing favorites and/or bookmarks in the links section of the user 98's homepage 99. At step 200-3, the one or more host servers 150 may store the one or more objects 101 in one or more databases 190. According to the method in FIG. 5, the user 98 may also assign object information 102 to any object 101 in the links section of the user 98's homepage 99. At step 200-4, the one or more host servers 150 receive data inputted by the user 98 and determine whether the data includes commands or instructions to assign object information 102 to one of the objects 101 in the links section of the user 98's homepage 99. At step 200-5, responsive to determining that the data includes commands or instructions to assign object information 102 to one of the objects 101 in the links section of the user 98's homepage 99, the one or more host servers 150 may assign object information 102 to one of the objects 101 in the links section of the user 98's homepage 99. At step 200-6, the one or more host servers 150 may store the object information 102 in one or more databases 190. Step 200-6 then proceeds to step 900-1 which is described below with reference to FIG. 6.

According to the method in FIG. 5, the user 98 may also assign object information 102 to an object 101, as well as add an object 101, on any page on site 145 or any website. At step 300-1, the one or more host servers 150 receive data inputted by the user 98 and determine whether the data includes commands or instructions to assign object information 102 to an object 101 on any page on site 145 or any website. At step 300-2, responsive to determining that the data includes commands or instructions to assign object information 102 to object 101 on any page on site 145 or any website, the one or more host servers 150 may assign the object information 102 to object 101 on any page on site 145 or any website. At step 300-3, the one or more host servers 150 may store the object information 102 in one or more databases 190. Step 300-3 then proceeds to step 900-1 which is described below with reference to FIG. 6.

According to the method in FIG. 5, the user 98 may also comment on, reply to, add one or more objects 101 or assign object information 102 to any objects 101 that appear in the updates section of the user 98's homepage 99, the homepages of the associated users of one or more degrees to the user 98 or other users' homepages 99. The user 98 may further set preferences to determine which updates the user 98 sees on the user 98's homepage 99. The user 98 may further set privacy settings to determine which updates other users may see on the user 98's homepage 99 as well as set privacy settings to determine which updates from the user 98's activity appears on other users homepages 99. At step 400-1, the one or more host servers 150 receive data inputted by the user 98 and determine whether the data includes commands or instructions to assign object information 102 to one of the objects 101 in the updates section of the user 98's homepage 99. At step 400-2, responsive to determining that the data includes commands or instructions to assign object information 102 to one of the objects 101 in the updates section of the user 98's homepage 99, the one or more host servers 150 may assign object information 102 to one of the objects 101 in the updates section of the user 98's homepage 99. At step 400-3, the one or more host servers 150 may store the object information 102 in one or more databases 190. Step 400-5 then proceeds to step 900-1 which is described below with reference to FIG. 6.

According to the method in FIG. 5, the user 98 may also add one or more objects 101, as well as assign object information 102, on any page on site 145 or any website. At step 500-1, the one or more host servers 150 receive data inputted by the user 98 and determine whether the data includes commands or instructions to add one or more objects 101 on any page on site 145 or any website. At step 500-2, responsive to determining that the data includes commands or instructions to add one or more objects 101 on any page on site 145 or any website, the one or more host servers 150 may add the one or more objects 101 on any page on site 145 or any website. At step 500-3, the one or more host servers 150 may store the one or more objects 101 in one or more databases 190. According to the method in FIG. 5, the user 98 may also assign object information 102 to any object 101 on any page on site 145 or any website. At step 500-4, the one or more host servers 150 receive data inputted by the user 98 and determine whether the data includes commands or instructions to assign object information 102 to one of the objects 101 on any page on site 145 or any website. At step 500-5, responsive to determining that the data includes commands or instructions to assign object information 102 to one of the objects 101 on any page on site 145 or any website, the one or more host servers 150 may assign object information 102 to one of the objects 101 on any page on site 145 or any website. At step 500-6, the one or more host servers 150 may store the object information 102 in one or more databases 190. Step 500-6 then proceeds to step 900-1 which is described below with reference to FIG. 6.

According to the method in FIG. 5, the user 98 may also perform a search for objects 101 on site 145 and World Wide Web from the front page, a homepage 99 or on any page on site 145 or any website using a search term. At step 600-1, the user 98 who may be logged in to site 145 or not logged in to site 145, may search for objects 101 on site 145 and World Wide Web from the front page, a homepage 99 or on any page on site 145 or any website using a search term. The user 98 may search for objects 101 on site 145 and World Wide Web from the user 98's homepage 99, the homepages of the associated users of one or more degrees to the user 98 or on any page on site 145 or any website using a search term. When searching, certain options may not be available to the user 98 if the user 98 is not logged in to site 145. At step 600-2, the user 98 who is logged in to site 145, may perform a search through only objects 101 on site 145 and World Wide Web that the associated users of one or more degrees to the user 98 or other users have added on site 145 through site 145 or any website; and/or the user 98 who is logged in to site 145, may perform a search through only objects 101 on site 145 and World Wide Web that specific associated users of one or more degrees to the user 98 or other users have added on site 145 through site 145 or any website. At step 600-3, the user 98 who is logged in to site 145, may perform a search through only objects 101 on site 145 and World Wide Web that the associated users of one or more degrees to the user 98 or other users have assigned object information 102 to on site 145 through site 145 or any website; and/or the user 98 who is logged in to site 145, may perform a search through only objects 101 on site 145 and World Wide Web that specific associated users of one or more degrees to the user 98 or other users have assigned object information 102 to on site 145 through site 145 or any website. At step 600-4, the user 98 who is logged in to site 145, may perform a search through only objects 101 on site 145 and World Wide Web that the associated users of one or more degrees to the user 98 or other users have added and assigned object information 102 to on site 145 through site 145 or any website; and/or the user 98 who is logged in to site 145, may perform a search through only objects 101 on site 145 and World Wide Web that specific associated users of one or more degrees to the user 98, or other users have added and assigned object information 102 to on site 145 through site 145 or any website. These searches for objects 101 on site 145 and World Wide Web described herein at steps 600-1, 600-2, 600-3 and 600-4 may take place from the front page, a homepage 99 or on any page on site 145 or any website. Step 600-4 then proceeds to step 700-1 or 800-1 which are both described below with reference to FIG. 6.

According to the method in FIG. 6, the user 98 may add one or more objects 101, as well as assign object information 102, on any page on site 145 or any website while searching for objects 101 on site 145 and World Wide Web from the front page, a homepage 99 or on any page on site 145 or any website using a search term. At step 700-1, the one or more host servers 150 receive data inputted by the user 98 and determine whether the data includes commands or instructions to add one or more objects 101 on any page on site 145 or any website while searching for objects 101 on site 145 and World Wide Web from the front page, a homepage 99 or on any page on site 145 or any website using a search term. At step 700-2, responsive to determining that the data includes commands or instructions to add one or more objects 101 on any page on site 145 or any website while searching for objects 101 on site 145 and World Wide Web from the front page, a homepage 99 or on any page on site 145 or any website using a search term, the one or more host servers 150 may add the one or more objects 101 on any page on site 145 or any website while searching for objects 101 on site 145 and World Wide Web from the front page, a homepage 99 or on any page on site 145 or any website using a search term. At step 700-3, the one or more host servers 150 may store the one or more objects 101 in one or more databases 190. According to the method in FIG. 6, the user 98 may also assign object information 102 to any object 101 while searching for objects 101 on site 145 and World Wide Web from the front page, a homepage 99 or on any page on site 145 or any website using a search term. At step 700-4, the one or more host servers 150 receive data inputted by the user 98 and determine whether the data includes commands or instructions to assign object information 102 to one of the objects 101 while searching for objects 101 on site 145 and World Wide Web from the front page, a homepage 99 or on any page on site 145 or any website using a search term. At step 700-5, responsive to determining that the data includes commands or instructions to assign object information 102 to one of the objects 101 while searching for objects 101 on site 145 and World Wide Web from the front page, a homepage 99 or on any page on site 145 or any website using a search term, the one or more host servers 150 may assign object information 102 to one of the objects 101 while searching for objects 101 on site 145 and World Wide Web from the front page, a homepage 99 or on any page on site 145 or any website using a search term. At step 700-6, the one or more host servers 150 may store the object information 102 in one or more databases 190. Step 700-6 then proceeds to step 900-1 which is described below with reference to FIG. 6.

According to the method in FIG. 6, the user 98 may also assign object information 102 to any objects 101 as well as add one or more objects 101 to objects 101 that appear on search on site 145 and World Wide Web from the front page, homepage 99 or any page on site 145 or any website using a search term. At step 800-1, the one or more host servers 150 receive data inputted by the user 98 and determine whether the data includes commands or instructions to assign object information 102 to one of the objects 101 that appear on search on site 145 and World Wide Web from the front page, homepage 99 or any page on site 145 or any website using a search term. At step 800-2, responsive to determining that the data includes commands or instructions to assign object information 102 to one of the objects 101 that appear on search on site 145 and World Wide Web from the front page, homepage 99 or any page on site 145 or any website using a search term, the one or more host servers 150 may assign the object information 102 to one of the objects 101 that appear on search on site 145 and World Wide Web from the front page, homepage 99 or any page on site 145 or any website using a search term. At step 800-3, the one or more host servers 150 may store the object information 102 in one or more databases 190. Step 800-3 then proceeds to step 900-1 which is described below with reference to FIG. 6.

As described above, steps 200-6, 300-3, 400-3, 500-6, 700-6 and 800-3 proceed to step 900-1 where the user 98 has the option to assign a rating to the object 101 based on object information 102. At step 900-1, the one or more host servers 150 receive data inputted by the user 98 and determine whether the data includes commands or instructions to assign a rating to the object 101 based on object information 102. At step 900-2, responsive to determining that the data includes commands or instructions to assign a rating to the object 101 based on object information 102, the one or more host servers 150 may assign a rating to the object 101 based on object information 102. At step 900-3, the one or more host servers 150 may store the rating in one or more databases 190. At step 900-4, the object 101's rating is recalculated taking into account the new rating the user 98 assigned to the object 101, any other ratings the object 101 may have had as well as each individual users', including the users' 98, user rating or user ratings, who have rated the object 101 as outlined in aspects of the present invention as described in the method in FIG. 4, based on object information 102. At step 900-5, the one or more host servers 150 may also assign the new recalculated rating to the object 101 based on object information 102. At step 900-6, the one or more host servers 150 may store the new assigned and recalculated rating in one or more databases 190. The object rating for object 101 may be recalculated when another user assigns a rating to the object 101 in the future or it may be recalculated when each individual users', including the users' 98, user rating or user ratings, who have rated the object 101 changes in the future. Each individual users', including the users' 98, rating of the object 101 may affect all future user ratings for all individual users who will also rate this object 101 in the future. At step 900-7, the user 98's user rating or user ratings are recalculated taking into account the new rating the user 98 just assigned to the object 101, any other ratings the object 101 may have had as well as each individual users', including the users' 98, user rating or user ratings, who have rated the object 101 as outlined in aspects of the present invention as described in the method in FIG. 4. At step 900-8, the one or more host servers 150 may also assign the new recalculated user rating or user ratings to the user 98. At step 900-9, the one or more host servers 150 may store the new assigned and recalculated user rating or user ratings in one or more databases 190. The user rating or user ratings for the user 98 may be recalculated when another user assigns a rating to the object 101 in the future or it may be recalculated when each individual users', including the users' 98, user rating or user ratings, who have rated the object 101 changes in the future. Each individual users', including the users' 98, rating of the object 101 may affect all future user ratings for all individual users who will also rate this object 101 in the future. At step 900-10, each individual users' user rating or user ratings who also rated this object 101 are recalculated taking into account the new rating the user 98 just assigned to the object 101, any other ratings the object 101 may have had as well as each individual users', including the users' 98, user rating or user ratings, who have rated the object 101 as outlined in aspects of the present invention as described in the method in FIG. 4. At step 900-11, the one or more host servers 150 may also assign the new recalculated individual user rating or user ratings to all users who also rated this object 101. At step 900-12, the one or more host servers 150 may store the new assigned and recalculated individual user rating or user ratings to all users who also rated this object 101 in one or more databases 190. The individual user rating or user ratings to all users who also rated this object 101 may be recalculated when another user assigns a rating to the object 101 in the future or it may be recalculated when each individual users', including the users' 98, user rating or user ratings, who have rated the object 101 changes in the future. Each individual users', including the users' 98, rating of the object 101 may affect all future user ratings for all individual users who will also rate this object 101 in the future.

Although illustrative embodiments have been shown and described herein in detail, it should be noted and will be appreciated by those skilled in the art that there may be numerous variations and other embodiments that may be equivalent to those explicitly shown and described. For example, the scope of the present invention is not necessarily limited in all cases to execution of the aforementioned steps in the order discussed. Unless otherwise specifically stated, terms and expressions have been used herein as terms of description, not of limitation. Accordingly, the invention is not to be limited by the specific illustrated and described embodiments (or the terms or expressions used to describe them).

What is claimed is:

1. A method, comprising:
(a) receiving by a computing system a command from a user, wherein the command is to rate an object with a particular rating, wherein the computing system includes at least one memory having at least one region for storing computer executable program code and at least one processor for executing the program code stored in the at least one memory, and wherein the computing system is connected to one or more databases in one or more non-transitory computer-readable storage media;
(b) transmitting by the computing system to a site the data; and
(c) receiving by the computing system a second data from the site, the second data including one or more object ratings for the object and one or more user ratings for the user calculated by the site based on the particular rating.

2. The method of claim 1, wherein the computing system is one or more programmed computers.

3. The method of claim 1, wherein the computing system is distributed over more than one physical location.

4. The method of claim 1, wherein the one or more non-transitory computer-readable storage media includes one or more of one or more harddrives, RAM, ROM, CD-ROM, DVD-ROM, floppy-disk drives, and solid-state memory drives.

5. The method of claim 1, wherein the one or more object ratings includes at least one overall rating for the object and at least one specific rating for the one or more object.

6. The method of claim 1, wherein the one or more user ratings includes at least one overall rating for the user and at least one specific rating for the user.

7. The method of claim 1, wherein the one or more object ratings are based on one or more object information.

8. The method of claim 1, wherein the one or more object ratings and the one or more user ratings are calculated using one or more weighted averages.

9. The method of claim 1, wherein the object is a link, a picture, a video, an audio file, other multimedia file, text, a phrase, a question, an interest, a network, a section on the site, a section on a website, a search term, a set of search results, news, a scholarly article, a blog, a blog entry, a wiki, a wiki entry, a comment, a quote, a piece of information, or a piece of communication.

10. The system of claim 7, wherein the one or more object information is one or more of a search term, a keyword, a related topic, an interest, an interest section on the site, a network, a network section on the site, an object, a rating based on object information, a rating based on quality, a piece of information, a definition, or a date.

11. The system of claim 10, wherein the definition is based on the object being recent news in a section on the site, being news in a section on the site, being associated with a wild in a section on the site, being associated with a search section related to a keyword phrase or question on the site, being associated with a photo, video, or other multimedia file or album in a section on the site, being associated with a photo area in a section on the site, being associated with a video area in a section on the site, being associated with a blog, being associated with a blog area in a section on the site, being associated with an area in a section on the site or on any website, or being associated with a section on the site or any website.

12. The system of claim 10, wherein the object information is the date the object was added to the site or a website, to an area or section on the site or a website, to a page on the site or a website, or to the object.

13. The method of claim 1, wherein the particular rating is represented by one or more numbers, letters, collections of stars, smiley faces, frown faces, colors, thumbs-up, thumbs-down, likes or dislikes, agree or disagree.

14. The method of claim 1, wherein the particular rating is based on a scale from 1 to 10, 1 to 100, 1 to 1000, A to Z.

15. The method of claim 1, wherein the one or more object ratings are represented by one or more numbers, letters, collections of stars, smiley faces, frown faces, colors, thumbs-up, thumbs-down, likes or dislikes, agree or disagree.

16. The method of claim 1, wherein the one or more object ratings are based on a scale from 1 to 10, 1 to 100, 1 to 1000, A to Z.

17. The method of claim 1, wherein the one or more user ratings are represented by one or more numbers, letters, collections of stars, smiley faces, frown faces, colors, thumbs-up, thumbs-down, likes or dislikes, agree or disagree.

18. The method of claim 1, wherein the one or more user ratings are based on a scale from 1 to 10, 1 to 100, 1 to 1000, A to Z.

19. The method of claim 1, wherein the site is a website.

20. The method of claim 1, wherein the site is a social networking website.

21. The method of claim 1, wherein the site is a search website.

22. The method of claim 1, wherein the site is a website that includes one or more servers.

23. The method of claim 1, wherein the command is received by the computing system from the user while the user is searching the site.

24. The method of claim 1, wherein the command is received by the computing system from the user while the user is searching the site from a page on the site.

25. The method of claim 1, wherein the command is received by the computing system from the user while the user is searching the site from a homepage on the site.

26. The method of claim 1, wherein the command is received by the computing system from the user while the user is searching the Internet.

27. The method of claim 1, where the command is received by the computing system while the user is on a second site.

28. The method of claim 1, wherein the command is received by the computing system from a browser window.

29. The method of claim 1, wherein the command is received from a program or application executing on a mobile phone, laptop, pda, netbook, tablet, smartphone or other mobile computing device.

30. The method of claim 1, wherein the command is received from a program or application executing on the user's computer.

31. The method of claim 1, wherein the command is received from a program or application embedded in a internet browser application on the user's computer.

32. The method of claim 1, further comprising:
(d) displaying by the computing system the one or more object ratings and user ratings.

33. A programmed computer system, comprising:
(a) at least one memory having at least one region for storing computer executable program code; and
(b) at least one processor for executing the program code stored in the memory, wherein the program code, when executed:
(b)(ii) transmits to a server data including a command to rate an object with a particular rating;
(b)(iii) receives a second data from the server, the second data including one or more new object ratings for the object and one or more new user ratings for the user calculated by the server based on the particular rating, one or more previous object ratings for the object, and one or more previous user ratings for the user.

34. The programmed computer system of claim 33, wherein the particular rating is based on one or more object information.

35. The programmed computer system of claim 33, wherein the one or more new object ratings and the one or more new user ratings are calculated using one or more weighted averages.

36. One or more non-transitory computer-readable storage media having computer executable software code stored thereon, the code for calculating a ranking, the code comprising:
(a) code for transmitting to a server data including a command to rate an object with a particular rating from a user; and
(b) code for receiving a second data from the server, the second data including an object rating for the object and a user rating for the user calculated by the server based on the particular rating, a previous user rating of the user, and a previous object rating of the object.

37. The one or more non-transitory computer-readable storage media of claim 36, wherein the one or more non-transitory computer-readable storage media is one or more of one or more harddrives, RAM, ROM, CD-ROM, DVD-ROM, floppy-disk drives, and solid-state memory drives.

38. The one or more non-transitory computer-readable storage media of claim 36, wherein the particular rating is based on one or more object information.

39. The one or more non-transitory computer-readable storage media of claim 36, wherein the object rating and the user rating are calculated using one or more weighted averages.

40. A computing system, comprising:
(a) one or more databases in one or more non-transitory computer-readable storage media;
(b) at least one memory having at least one region for storing computer executable program code; and
(c) at least one processor for executing the program code stored in the at least one memory, wherein the program code comprises:
(c)(i) code to receive an instruction from a user, wherein the instruction is to rate an object;
(c)(ii) code to calculate an object rating for the object based on the rating, one or more previous user ratings of the user, one or more other user ratings of one or more other users that previously provided one or more previous object ratings of the object, the one or more previous object ratings of the object;
(c)(iii) code to store the object rating in the one or more databases; and
(c)(iv) code to post the object rating to a site.

41. The computing system of claim 40, wherein the one or more non-transitory computer-readable storage media includes one or more of one or more harddrives, RAM, ROM, CD-ROM, DVD-ROM, floppy-disk drives, and solid-state memory drives.

42. The computing system of 40, wherein the rating of the object is based on one or more object information.

43. The computing system of claim 40, wherein the object rating is calculated using one or more weighted averages.

44. A method for calculating the rating of an object, the method comprising:
(a) receiving by a computing system data from a user, the data including a rating of an object and the computing system having access to one or more previous user ratings of the user, one or more other user ratings of one or more other users that previously provided one or more previous object ratings of the object, the one or more previous object ratings of the object, and one or more user ratings of one or more associated users to a particular degree to the user, wherein the computing system includes at least one memory having at least one region for storing computer executable program code and at least one processor for executing the program code stored in the at least one memory;
(b) calculating by the computing system an object rating for the object and one or more user ratings for the user based on the rating, the one or more previous user ratings of the user, the one or more other user ratings of the one or more other users that previously provided the one or more previous object ratings of the object, the one or more previous object ratings of the object, and the one or more user ratings of the one or more associated users to the particular degree to the user; and
(c) storing by the computing system the object rating and the one or more user ratings in a non-transitory computer-readable storage media.

45. The method of claim 44, wherein the one or more non-transitory computer-readable storage media includes one or more of one or more harddrives, RAM, ROM, CD-ROM, DVD-ROM, floppy-disk drives, and solid-state memory drives.

46. The method of claim 44, wherein the rating of the object is based on one or more object information.

47. The method of claim 44, wherein the object rating and the one or more user ratings are calculated using one or more weighted averages.

48. A method, comprising:
(a) receiving by a computing system a rating of an object from a user on a site, wherein the user provided the rating of the object on the site, and wherein the computing system includes at least one memory having at least one region for storing computer executable program code and at least one processor for executing the program code stored in the at least one memory and is connected to one or more databases in one or more non-transitory computer-readable storage media;
(b) calculating by the computing system one or more object ratings for the object based on the rating;
(c) calculating by the computing system one or more user ratings for the user based on the rating; and
(d) storing by the computing system the one or more object ratings and user ratings in the one or more databases.

49. The method of claim 48, wherein the one or more non-transitory computer-readable storage media includes one or more of one or more harddrives, RAM, ROM, CD-ROM, DVD-ROM, floppy-disk drives, and solid-state memory drives.

50. The method of claim 48, wherein the rating of the object is based on one or more object information.

51. The method of claim 48, wherein the one or more object ratings and the one or more user ratings are calculated using one or more weighted averages.

52. A method, comprising:
(a) receiving by a computing system a command from a user, wherein the command is to add an object and object information associated with the object, wherein the computing system includes at least one memory having at least one region for storing computer executable program code and at least one processor for executing the program code stored in the at least one memory and is connected to one or more databases in one or more non-transitory computer-readable storage media;
(b) determining by the computing system whether the command includes adding an object;
(c) responsive to determining that the command includes adding the object:
(c)(i) adding by the computing system the object to a site;
(c)(ii) storing by the computing system the object in the one or more databases;
(d) determining by the computing system whether the command includes adding one or more object information associated with the object;
(e) responsive to determining that the command includes adding the one or more object information associated with the object:
(e)(i) adding by the computing system the one or more object information to the site;
(e)(ii) storing by the computing system the one or more object information in the one or more databases;
(e)(iii) determining by the computing system whether the object information includes a rating for the object;
(e)(iv) responsive to determining that the object information includes a rating for the object:
(e)(iv)(A) calculating by the computing system one or more object ratings for the object based on the rating;
(e)(iv)(B) calculating by the computing system one or more user ratings for the user based on the rating;
(e)(v) storing by the computing system the one or more object ratings and user ratings in the one or more databases.

53. The method of claim 52, wherein the computing system is one or more programmed computers.

54. The method of claim 52, wherein the computing system is distributed over more than one physical location.

55. The method of claim 52, wherein the one or more non-transitory computer-readable storage media includes one or more of one or more harddrives, RAM, ROM, CD-ROM, DVD-ROM, floppy-disk drives, and solid-state memory drives.

56. The method of claim 52, wherein the one or more object ratings includes at least one overall rating for the object and at least one specific rating for the object.

57. The method of claim 52, wherein the one or more user ratings includes at least one overall rating for the user and at least one specific rating for the user.

58. The method of claim 52, wherein the rating of the object is based on one or more object information.

59. The method of claim 52, wherein the calculations in steps (e)(iv)(A) and (e)(iv)(B) further comprise calculating using one or more weighted averages.

60. The method of claim 52, wherein the object is a link, a picture, a video, an audio file, other multimedia file, text, a phrase, a question, an interest, a network, a section on the site, a section on a website, a search term, a set of search results, news, a scholarly article, a blog, a blog entry, a wiki, a wild entry, a comment, a quote, a piece of information, or a piece of communication.

61. The method of claim 52, wherein the object information is one or more of a search term, a keyword, a related topic, an interest, an interest section on the site, a network, a network section on the site, an object, a rating based on object information, a rating based on quality, a piece of information, a definition, or a date.

62. The system of claim 61, wherein the definition is based on the object being recent news in a section on the site, being news in a section on the site, being associated with a wild in a section on the site, being associated with a search section related to a keyword phrase or question on the site, being associated with a photo, video, or other multimedia file or album in a section on the site, being associated with a photo area in a section on the site, being associated with a video area in a section on the site, being associated with a blog, being associated with a blog area in a section on the site, being associated with an area in a section on the site or on any website, or being associated with a section on the site or any website.

63. The system of claim 61, wherein the object information is the date the object was added to the site or a website, to an area or section on the site or a website, to a page on the site or a website, or to the object.

64. The method of claim 52, wherein the one or more object ratings are represented by one or more numbers, letters, collections of stars, smiley faces, frown faces, colors, thumbs-up, thumbs-down, likes or dislikes, agree or disagree.

65. The method of claim 52, wherein the one or more object ratings are based on a scale from 1 to 10, 1 to 100, 1 to 1000, A to Z.

66. The method of claim 52, wherein the one or more user ratings are represented by one or more numbers, letters, collections of stars, smiley faces, frown faces, colors, thumbs-up, thumbs-down, likes or dislikes, agree or disagree.

67. The method of claim 52, wherein the one or more user ratings are based on a scale from 1 to 10, 1 to 100, 1 to 1000, A to Z.

68. The method of claim 52, wherein the command is received by the computing system when the user is on a website.

69. The method of claim 52, wherein the command is received by the computing system when the user is on a social networking website.

70. The method of claim 52, wherein the command is received by the computing system when the user is on a search website.

71. The method of claim 52, wherein the computing system includes one or more servers.

72. The method of claim 52, wherein the command is received by the computing system from the user while the user is searching the site.

73. The method of claim 52, wherein the command is received by the computing system from the user while the user is searching the site from a page on the site.

74. The method of claim 52, wherein the command is received by the computing system from the user while the user is searching the site from a homepage on the site.

75. The method of claim 52, wherein the command is received by the computing system from the user while the user is searching the Internet.

76. The method of claim 52, wherein the command is received by the computing system while the user is on a second site.

77. The method of claim 52, wherein the command is received from a browser window.

78. The method of claim 52, wherein the command is received from a program or application executing on a mobile phone, laptop, pda, netbook, tablet, smartphone or other mobile computing device.

79. The method of claim 52, wherein the command is received from a program or application executing on the user's computer.

80. The method of claim 52, wherein the command is received from a program or application embedded in a internet browser application on the user's computer.

81. The method of claim 52, further comprising:
(e)(vi) displaying the one or more object ratings and user ratings on the site.

82. The method of claim 52, wherein the one or more objects are added to one or more sections on one or more sites based on the one or more object information.

83. A computing system, comprising:
(a) one or more databases in one or more non-transitory computer-readable storage media;
(b) at least one memory having at least one region for storing computer executable program code; and
(c) at least one processor for executing the program code stored in the at least one memory, wherein the program code comprises:
(c)(i) code to receive an instruction, wherein the instruction is to add an object and or interact with the object;
(c)(ii) code to determine whether the instruction is to add an object and or interact with the object;
(c)(iii) responsive to determining that the instruction is to add the object:
(c)(iii)(A) code to add the object to a webpage;
(c)(iii)(B) code to store the object in the one or more databases;
(c)(iv) responsive to determining that the instruction is to interact with the object:
(c)(iv)(A) code to receive a second instruction, wherein the second instruction is to rate the object and includes a rating for the object;
(c)(iv)(B) code to calculate an object rating for the object based on the rating, the previous object ratings, and the previous user ratings; and
(c)(iv)(C) code to calculate a user rating for the user based on the rating, the previous object ratings, and the previous user ratings;
(c)(v) code to store the one or more object ratings and user ratings in the one or more databases.

84. The computing system of claim 83, wherein the one or more non-transitory computer-readable storage media includes one or more of one or more harddrives, RAM, ROM, CD-ROM, DVD-ROM, floppy-disk drives, and solid-state memory drives.

85. The computing system of claim 83, wherein the rating of the object is based on one or more object information.

86. The computing system of claim 83, wherein the calculations in steps (c)(iv)(B) and (c)(iv)(C) further comprise calculating using one or more weighted averages.

87. The computing system of claim 83, wherein the one or more objects are added to one or more sections on one or more sites based on one or more object information.

88. A method, comprising:
(a) receiving by a computing system a command from a user, wherein the command is to add an object to a webpage and or interact with the object, wherein the computing system includes at least one memory having at least one region for storing computer executable program code and at least one processor for executing the program code stored in the at least one memory and is connected to one or more databases in one or more non-transitory computer-readable storage media;
(b) determining by the computing system whether the command is to add an object to the webpage and or interact with the object;
(c) responsive to determining that the command is to add the object to the webpage on a site:
(c)(i) adding by the computing system the object to the one or more databases; and
(c)(ii) adding by the computing system the object to the webpage; and
(d) responsive to determining that the command is to interact with the object:
(d)(i) receiving by the computing system a second command, wherein the second command is to add object information for the object;
(d)(ii) receiving by the computing system a third command, wherein the third command is to add a rating for the object;
(d)(iii) calculating by the computing system one or more object ratings for the object based on the rating;
(d)(iv) calculating by the computing system one or more user ratings for the user based on the rating; and
(d)(v) storing by the computing system the one or more object information and the one or more object ratings and user ratings in the one or more databases.

89. The method of claim 88, wherein the one or more non-transitory computer-readable storage media includes one or more of one or more harddrives, RAM, ROM, CD-ROM, DVD-ROM, floppy-disk drives, and solid-state memory drives.

90. The method of claim 88, wherein the rating of the object is based on one or more object information.

91. The method of claim 88, wherein the calculations in steps (d)(iii) and (d)(iv) further comprise calculating using one or more weighted averages.

92. The method of claim 88, wherein the one or more objects are added to one or more sections on one or more sites based on one or more object information.

93. A method, comprising:
(a) receiving by a computing system a command from a user, wherein the command is to add an object and or interact with the object, wherein the computing system includes at least one memory having at least one region for storing computer executable program code and at least one processor for executing the program code stored in the at least one memory and is connected to one or more databases in one or more non-transitory computer-readable storage media;
(b) determining by the computing system whether the command is to add an object and or interact with the object;
(c) responsive to determining that the command is to add the object:
(c)(i) adding by the computing system the object to a site; and
(c)(ii) storing by the computing system the object in the one or more databases; and
(d) responsive to determining that the command is to interact with the object:
(d)(i) receiving by the computing system a second command, wherein the second command is to rate the object and includes a rating for the object;
(d)(ii) calculating by the computing system one or more object ratings for the object based on the rating;
(d)(iii) calculating by the computing system one or more user ratings for the user based on the rating; and
(d)(iv) storing by the computing system the one or more object ratings and user ratings in the one or more databases.

94. The method of claim 93, wherein the one or more non-transitory computer-readable storage media includes one or more of one or more harddrives, RAM, ROM, CD-ROM, DVD-ROM, floppy-disk drives, and solid-state memory drives.

95. The method of claim 93, wherein the rating of the object is based on one or more object information.

96. The method of claim 93, wherein the calculations in steps (d)(ii) and (d)(iii) further comprise calculating using one or more weighted averages.

97. The method of claim 93, wherein the one or more objects are added to one or more sections on one or more sites based on one or more object information.

98. A method, comprising:
(a) receiving by a computing system a command from a user to perform a search having one or more search criteria, wherein the computing system includes at least one memory having at least one region for storing computer executable program code and at least one processor for executing the program code stored in the at least one memory and is connected to one or more databases in one or more non-transitory computer-readable storage media, and wherein the one or more databases include one or more objects each having one or more object information that includes at least one object rating and at least one identifier designating each user that rated each object, and wherein the user having one or more user ratings; and
(b) displaying one or more search results on a page including one or more of the one or more objects having the one or more object information relevant to the one or more search criteria, wherein the one or more of the one or more objects are sorted on the page based on each of their object ratings.

99. The method of claim 98, wherein the computing system is one or more programmed computers.

100. The method of claim 98, wherein the computing system is distributed over more than one physical location.

101. The method of claim 98, wherein the one or more non-transitory computer-readable storage media includes one or more of one or more harddrives, RAM, ROM, CD-ROM, DVD-ROM, floppy-disk drives, and solid-state memory drives.

102. The method of claim 98, wherein the object ratings of the one or more objects include at least one overall rating for the object and at least one specific rating for the one or more object.

103. The method of claim 98, wherein each user who rated each object includes a user rating of at least one overall rating for the user and at least one specific rating for the user.

104. The method of claim 98, wherein the object ratings of the one or more objects are based on one or more object information.

105. The method of claim 98, wherein the object ratings of the one or more objects and the user ratings of each user that rated each object are calculated using one or more weighted averages.

106. The method of claim 98, wherein the one or more objects are at least one of a link, a picture, a video, an audio file, other multimedia file, text, a phrase, a question, an interest, a network, a section on the site, a section on a website, a search term, a set of search results, news, a scholarly article, a blog, a blog entry, a wild, a wild entry, a comment, a quote, apiece of information, or a piece of communication.

107. The method of claim 98, wherein the one or more object information is one or more of a search term, a keyword, a related topic, an interest, an interest section on the site, a network, a network section on the site, an object, a rating based on object information, a rating based on quality, a piece of information, a definition, or a date.

108. The system of claim 107, wherein the definition is based on the object being recent news in a section on the site, being news in a section on the site, being associated with a wild in a section on the site, being associated with a search section related to a keyword phrase or question on the site, being associated with a photo, video, or other multimedia file or album in a section on the site, being associated with a photo area in a section on the site, being associated with a video area in a section on the site, being associated with a blog, being associated with a blog area in a section on the site, being associated with an area in a section on the site or on any website, or being associated with a section on the site or any website.

109. The system of claim 107, wherein the object information is the date the object was added to the site or a website, to an area or section on the site or a website, to a page on the site or a website, or to the object.

110. The method of claim 98, wherein the object ratings of the one or more objects are represented by one or more numbers, letters, collections of stars, smiley faces, frown faces, colors, thumbs-up, thumbs-down, likes or dislikes, agree or disagree.

111. The method of claim 98, wherein the object ratings of the one or more objects are based on a scale from 1 to 10, 1 to 100, 1 to 1000, A to Z.

112. The method of claim 98, wherein the one or more user ratings of each user that rated each object are represented by one or more numbers, letters, collections of stars, smiley faces, frown faces, colors, thumbs-up, thumbs-down, likes or dislikes, agree or disagree.

113. The method of claim 98, wherein the one or more user ratings of each user that rated each object are based on a scale from 1 to 10, 1 to 100, 1 to 1000, A to Z.

114. The method of claim 98, wherein the search criteria includes objects on a website.

115. The method of claim 98, wherein the search criteria includes objects on a social networking website.

116. The method of claim 98, wherein the search criteria includes objects on a search website.

117. The method of claim 98, wherein the search criteria is on a website that includes one or more servers.

118. The method of claim 98, wherein the command is received by the computing system from the user on a homepage associated with the user.

119. The method of claim 98, wherein the command is received by the computing system from the user on a second page on a site.

120. The method of claim 98, wherein the command is received by the computing system when the user is searching the Internet.

121. The method of claim 98, wherein the page is a on a first site, and the command is received by the computing system from the user on a second site.

122. The method of claim 98, wherein the command is received from a browser window.

123. The method of claim 98, wherein the command is received from a program or application executing on a mobile phone, laptop, pda, netbook, tablet, smartphone or other mobile computing device.

124. The method of claim 98, wherein the command is received from a program or application executing on the user's computer.

125. The method of claim 98, wherein the command is received from a program or application embedded in a interne browser application on the user's computer.

126. The method of claim 98 wherein the search criteria includes objects added by the user.

127. The method of claim 98, wherein the search criteria includes objects rated by the user.

128. The method of claim 98, wherein the search criteria includes objects added by one or more other users.

129. The method of claim 98, wherein the search criteria includes objects rated by one or more other users.

130. The method of claim 98, wherein the search criteria includes objects added by one or more associated users to a particular degree to the user.

131. The method of claim 98, wherein the search criteria includes objects rated by one or more associated users to a particular degree to the user.

132. A method, comprising:
(a) receiving by a computing system a command from a user to perform a search having one or more search criteria, wherein the computing system includes at least one memory having at least one region for storing computer executable program code and at least one processor for executing the program code stored in the at least one memory and is connected to one or more databases in one or more non-transitory computer-readable storage media, wherein the one or more databases include one or more objects each having one or more object information that includes at least one object rating and at least one identifier designating each user that rated each object, and wherein the user having one or more user ratings; and
(b) displaying one or more search results on a page including one or more of the one or more objects having the one or more object information relevant to the one or more search criteria, wherein the one or more of the one or more objects are sorted on the page based at least on the one or more user ratings.

133. The method of claim 132, wherein the rating of the object is based on one or more object information.

134. The method of claim 132, wherein at least one object rating and the one or more user ratings are calculated using one or more weighted averages.

135. A computing system, comprising:
(a) at least one memory having at least one region for storing computer executable program code; and
(b) at least one processor for executing the program code stored in the memory, wherein the program code, when executed:
(b)(i) allows a user to access a site;
(b)(ii) displays a page on the site to the user, the page including one or more first objects that the user assigned one or more first object information and one or more second objects that one or more associated users to the user to a particular degree assigned one or more second object information; and
(b)(iii) updating the page with one or more first new objects that the user assigned one or more first new object information and one or more second new objects that the one or more associated users to the user to the particular degree assigned one or more second new object information.

136. The computing system of claim 135, wherein the page is a home page associated with the user.

137. The computing system of claim 135, wherein the first object information, second object information, first new object information and second new object information each includes a rating associated with the first object, second object, first new object and second new object, respectively.

138. The system of claim 137, wherein the ratings associated with the first object, second object, first new object, second new object are based on one or more object information.

139. The system of claim 137, wherein the ratings associated with the first object, second object, first new object, second new object are calculated using one or more weighted averages.

140. The method of claim 135, wherein the user and one or more associated users to the user to a particular degree have one or more user ratings calculated using one or more weighted averages.

141. A computing system, comprising:
(a) at least one memory having at least one region for storing computer executable program code; and
(b) at least one processor for executing the program code stored in the memory, wherein the program code, when executed:
(b)(i) allows a user to access a site and designate one or more subject matter classifications, wherein the subject matter classifications designate one or more categories of subject matter in one or more sections of the site or one or more other sites; and
(b)(ii) displays a page on the site to the user, the page including one or more objects having one or more object information, wherein the one or more object information includes at least one of the one or more subject matter classifications that the user designated.

142. The computing system of claim 141, wherein the page further includes one or more second objects having one or more second object information, wherein the one or more second object information includes at least one other subject matter classification that one or more associated users to the user to a particular degree designated on the site.

143. The computing system of claim 141, wherein the program code further updates the page to include one or more second objects having one or more second object information, wherein the one or more second object information includes at least one other subject matter classification that one or more associated users to the user to a particular degree designated on the site.

144. The computing system of claim 141, wherein the page is a homepage associated with the user.

145. The computing system of claim 141, wherein the one or more object information includes one or more ratings associated with the object.

146. The system of claim 145, wherein the one or more ratings are based on the one or more object information.

147. The system of claim 145, wherein the one or more ratings are calculated using one or more weighted averages.

148. The computing system of claim 141, wherein the user has one or more user ratings calculated using one or more weighted averages.

149. A computing system, comprising:
(a) at least one memory having at least one region for storing computer executable program code; and
(b) at least one processor for executing the program code stored in the memory, wherein the program code, when executed:
(b)(i) displays a webpage on a site associated with a particular subject matter, the page including one or more objects having one or more object information that references the particular subject matter; and
(b)(ii) allows one or more users to update the one or more object information.

150. The computing system of claim 149, wherein the program code, when executed, further updates the webpage with the one or more objects having one or more new object information that references the particular subject matter.

151. The computing system of claim 149, wherein the program code, when executed, further updates a second webpage with the one or more objects having one or more new object information that references the particular subject matter.

152. The computing system of claim 149, wherein the program code, when executed, further updates the webpage by adding one or more new objects having one or more new object information that references the particular subject matter.

153. The computing system of claim 149, wherein the program code, when executed, further updates a second webpage by adding one or more new objects having one or more new object information that references the particular subject matter.

154. The computing system of claim 149, wherein the program code, when executed, further updates the webpage by removing the one or more objects that no longer have object information that references the particular subject matter.

155. The computing system of claim 149, wherein the program code, when executed, further updates a second webpage by removing the one or more objects that no longer have object information that references the particular subject matter.

156. The computing system of claim 149, wherein the webpage is a homepage associated with one of the one or more users.

157. The computing system of claim 149, wherein the webpage is a search page.

158. The computing system of claim 149, wherein the one or more object information includes one or more ratings.

159. The system of claim 158 wherein the one or more ratings are based on the one or more object information.

160. The system of claim 158 wherein the one or more ratings are calculated using one or more weighted averages.

161. The computing system of claim 149 wherein the one or more users have one or more user ratings calculated using one or more weighted averages.

162. The system of claim 153, wherein the one or more new objects are added to one or more sections on one or more sites based on the one or more object information.

163. A method, comprising:
(a) receiving by a computing system a command from a user, wherein the computing system includes at least one memory having at least one region for storing computer executable program code and at least one processor for executing the program code stored in the at least one memory and is connected to one or more databases in one or more non-transitory computer-readable storage media, wherein the command is to add an object, and wherein the object includes a link and data associated with a minimum degree of change associated with the link required for notification of the user;
(b) determining by the computing system whether the command is to add an object;
(c) responsive to determining that the command is to add the object:
(c)(i) adding by the computing system the object to a site;
(c)(ii) storing by the computing system the object in the one or more databases;
(d) retrieving by the computing system a first webpage associated with the link;
(e) storing by the computing system the first webpage in the one or more databases;
(f) retrieving by the computing system a second webpage associated with the link;
(g) storing by the computing system the second webpage in the one or more databases;
(h) determining by the computing system a calculated degree of change, wherein said determination of a calculated degree of change includes comparing the first webpage with the second webpage and calculating a percentage difference between the first webpage and the second webpage;
(i) determining by the computing system whether the calculated degree of change is equal to or greater than the minimum degree of change; and
(j) responsive to determining that the calculated degree of change is equal to or greater than the minimum degree of change, notifying by the computing system the user that the link has updated.

164. The method of claim 163, further comprising, displaying by the computing system a third webpage notifying the user that the link has updated.

165. The method of claim 163, wherein the minimum degree of change is determined by the user.

166. The method of claim 163, wherein the minimum degree of change is a percentage.

167. The system of claim 164, wherein the notification that the link has updated is in an updates section of the third webpage.

168. The system of claim 164, wherein the third webpage is a homepage.

169. A programmed computer system, comprising:
(a) at least one memory having at least one region for storing computer executable program code;
(b) at least one non-transitory computer-readable storage media;
(c) an internet browser installed on the programmed computer system;
(d) a software application installed on the programmed computer system's internet browser and stored in the at least one non-transitory computer-readable storage media, wherein the software application includes an interface to assign one or more object information associated with a webpage to a server, and or to assign one or more object information associated with one or more objects on the webpage to the server;
(e) at least one processor for executing the program code stored in the memory, wherein the program code, when executed:
(e)(i) receives a request from a user to display the webpage;
(e)(ii) displays the webpage in the internet browser;
(e)(iii) receives one or more first commands from the user to assign one or more object information associated with the webpage to the server and or to assign one or more object information associated with one or more objects on the webpage to the server, wherein the one or more first commands are received via the interface on the internet browser;
(e)(iv) determines whether the one or more first commands includes assigning one or more object information associated with the webpage to the server;
(e)(v) responsive to determining that the one or more first commands includes assigning one or more object information associated with the webpage to the server, transmits to the server data including one or more second commands to add the webpage and the one or more object information associated with the webpage to the server, wherein the one or more second commands are transmitted to the server via the interface on the internet browser;
(e)(vi) determines whether the one or more first commands includes one or more object information associated with one or more objects on the webpage to the server; and
(e)(vii) responsive to determining that the one or more first commands includes one or more object information associated with one or more objects on the webpage to the server, transmits to the server data including one or more third commands to add the one or more objects and the one or more object information associated with one or more objects on the webpage to the server, wherein the one or more third commands are transmitted to the server via the interface on the internet browser.

170. The programmed computer system of claim 169, wherein the program code, when executed, further:
transmits to the server data including one or more fourth commands to add the webpage and the one or more objects to one or more sections on one or more sites based on the one or more object information.

171. The programmed computer system of claim 169, wherein the program code, when executed, further:
transmits to the server data including one or more first object ratings associated with the webpage, one or more first user ratings associated with the user, one or more second object ratings associated with the object, and one or more second user ratings associated with the user, each of which are calculated based on a particular rating.

172. The system of claim 171, wherein the one or more object ratings are based on the one or more of the one or more object information.

173. The system of claim 171, wherein the one or more first object ratings, the one or more first user ratings, the one or more second object ratings, and the one or more second user ratings, are calculated using one or more weighted averages.

174. A computing system, comprising:
(a) at least one memory having at least one region for storing computer executable program code; and
(b) at least one processor for executing the program code stored in the memory, wherein the program code, when executed:
(b)(i) displays a webpage on a site associated with an area, section or subsection of the site, wherein the webpage includes one or more objects having one or more object information associated with the area, section or subsection, and wherein the one or more objects on the webpage are sorted on the webpage based on their object ratings;
(b)(ii) receives from one or more users edits to one or more of the one or more object information; and
(b)(iii) updates the webpage based on the edits received from the one or more users.

175. The computing system of claim 174, wherein the update to the webpage includes resorting one or more of the one or more objects on the webpage based on the edits received from the one or more users.

176. The computing system of claim 174, wherein edits from the one or more users includes adding or updating an object rating, and wherein the update to the webpage includes resorting one or more of the one or more objects on the webpage based on the object rating.

177. The computing system of claim 174, wherein the update to the webpage includes removing from the webpage one or more of the one or more objects based on the edits received from the one or more users.

178. The computing system of claim 174, wherein the program code, when executed, further displays a second webpage on the site associated with a second area, second section or second subsection of the site, wherein the second webpage includes one or more second objects having one or more second object information associated with the second area, second section or second subsection, and wherein the one or more second objects on the second webpage are sorted on the webpage based on their object ratings.

179. The system of claim 178, wherein the program code, when executed further:
receives one or more second edits from the one or more users including replacing the one or more object information associated with the area, section or subsection with one or more second object information associated with the second area, second section or second subsection; and
updates the second webpage to include one or more of the one or more objects based on the edits received from the one or more users.

180. The system of claim 179 wherein the update to the webpage includes removing from the webpage one or more of the one or more objects based on the edits received from the one or more users.
